(19) United States
(12) Patent Application Publication
(10) Pub. No.: US 2026/0197885 A1
(43) Pub. Date: Jul. 9, 2026

(54) METHOD AND APPARATUS FOR P2P GROUP COMMUNICATION BETWEEN NON-AP MULTI-LINK DEVICES

(71) Applicant: CANON KABUSHIKI KAISHA, Tokyo (JP)

(72) Inventors: Pascal VIGER, JANZE (FR); Romain GUIGNARD, RENNES (FR)

(21) Appl. No.: 19/132,549

(22) PCT Filed: Nov. 6, 2023
(86) PCT No.: PCT/EP2023/080871

§ 371 Date: May 23, 2025

(30) Foreign Application Priority Data
Nov. 25, 2022 (GB) 2217701.8
Sep. 1, 2023 (GB) 2313389.5

(51) Int. Cl. H04W 76/15; H04L 43/065

(52) U.S. Cl. CPC H04W 76/15; H04L 43/065

(57) ABSTRACT

The present invention concerns a method of transmission in a wireless network, the method comprising: configuring a first affiliated non-Access Point, non-AP, station of a non-AP Multi Link Device, MLD, as a Peer to Peer, P2P, station for communicating with a peer station in a first Basic Service Set, BSS, forming a P2P group; and configuring at least one second affiliated non-AP station of the non-AP MLD as station for communicating with an AP in a second BSS.

### FIELD OF THE INVENTION

The present invention relates generally to communication networks and more specifically to Peer-to-Peer (P2P) communication methods in wireless network comprising a plurality of stations clustered into a plurality of multi-link entities, one of these multi-link entities playing the role of an access point, the other multi-link entities being connected to the access point, and corresponding devices.

The invention finds application in particular to the access of an 802.11be/uhr/bn standard network.

### BACKGROUND OF INVENTION

Wireless communication networks are widely deployed to provide various communication services such as voice, video, packet data, messaging, broadcast, etc.

These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth and decreasing latency requirements that are demanded for wireless communications systems in high-density environments, multi-user (MU) schemes are being developed to allow a single access point (AP) to schedule MU transmissions, i.e. multiple simultaneous transmissions to or from non-AP stations, in the wireless network. For example, one of such MU schemes has been adopted by the Institute of Electrical and Electronics Engineers (IEEE) in the 802.11ax standard, draft version 3.0 (D3.0) of June 2018.

Thanks to the MU feature, a station has the opportunity to gain access to the wireless medium via two access schemes: the MU scheme and the conventional Enhanced Distributed Channel Access—EDCA (Single User, SU) scheme.

However, SU and MU schemes directly compete one against the other to gain access to the wireless medium (by the AP for MU schemes, by a non-AP station for the SU scheme). In high density environment, this competition generates a large amount of undesirable collisions, thereby degrading latency and overall useful data throughput. Therefore, some mechanisms were introduced to favor MU scheme compared to SU scheme.

As a successor of 802.11ax, the 802.11be standard, namely EHT standing for “Extremely High Throughput”, is being considering a feature called multi-link operation (MLO), wherein a single device can support multiple links and the data of the device can be delivered to another device through the multiple links. Multi-link feature can increase the peak/average throughput of the device. The Multi-link capability is negotiated during the initial association between a non-AP station and the intended AP.

A multi-link device is a station comprising several affiliated stations. Each affiliated station is dedicated to handling one link for the station. An Access Point multi-link device (AP MLD) is a multi-link device, wherein each affiliated station (STA) within the MLD is an AP. A non-AP multi-link device (non-AP MLD) is a multi-link device, wherein each affiliated station within the MLD is a non-AP STA. An affiliated STA provides link-specific, lower medium access protocol (MAC) services within the MLD.

The multi-link operation is not adapted to bandwidth-demanding communication services between two non-AP stations, e.g., video-based services such as gaming, virtual reality, streaming applications. This is because all the communications, besides any used link(s), go through the AP, thereby doubling the air-time for transmission but also the number of medium accesses and thus of medium access time.

Indeed, efficient use of the resources of a wireless local-area network (WLAN) is important to provide bandwidth and acceptable response times to the users of the WLAN. In this context of bandwidth-demanding communication services between two non-AP stations, the duration of the association of the two non-AP stations is also an issue and should be kept as short as possible.

### SUMMARY OF THE INVENTION

The present invention has been devised to address one or more of the foregoing concerns.

The invention relates to a non-AP Multi-link device (MLD) that is capable of configuring one of its affiliated stations as a peer-to-peer (P2P) station to form a P2P group while other affiliated stations keep operating in the WLAN.

According to an aspect of the invention, it is proposed a method of transmission in a wireless network, the method comprising:
configuring a first affiliated non-Access Point, non-AP, station of a non-AP Multi Link Device, MLD, as a Peer to Peer, P2P, station for communicating with a peer station in a first Basic Service Set, BSS, forming a P2P group; and
configuring at least one second affiliated non-AP station of the non-AP MLD as station for communicating with an AP in a second BSS.

In some embodiments, the second affiliated non-AP stations of the non-AP MLD are configured for communicating with respective affiliated AP stations of an AP MLD.

In some embodiments, the first affiliated non-AP station ceases transmission to the AP MLD once configured for communicating in the P2P group.

In some embodiments, the method further comprises:
disassociating the first affiliated non-AP station from an affiliated AP station of the AP MLD prior configuring the first affiliated non-AP station as a P2P station.

In some embodiments, the first affiliated non-AP station being configured to communicate with the peer station on a first channel of the first BSS and the at least one second affiliated non-AP station being configured to communicate with the AP on at least one second channel of the second BSS, the method comprises:
reporting the P2P group and the first channel, by the at least one second affiliated non-AP station of the non-AP MLD, to the AP MLD.

In some embodiments, reporting the P2P group comprises transmitting a P2P Information Element, IE.

In some embodiments, the P2P IE is transmitted in a P2P Invitation Request frame transmitted on the second channel by the at least one second affiliated non-AP station to the AP MLD to be transmitted to another station connected to the AP MLD.

In some embodiments, the P2P IE is transmitted in a Multi-Link IE of a Probe Request frame.

In some embodiments, the Probe Request frame further comprises a Reduced Neighbour Report, RNR, IE identifying the first non-AP affiliated station operating as a Group Owner, GO, of the P2P group, in addition to the Multi-Link IE including information of the GO, and wherein the RNR IE and ML IE include an MLD ID subfield and a link ID subfield, respectively set to same value but distinct from respective subfield values used for the second BSS.

In some embodiments, the method further comprises:
transmitting the P2P IE, by the AP MLD, in a Probe Response frame or in a beacon frame on the second channel.

In some embodiments, the P2P IE is included in a per-STA profile in a first Basic Multi-Link IE.

In some embodiments, the beacon frame or Probe Response frame further comprise, in addition to the first Basic Multi-Link IE:
a RNR IE identifying the AP affiliated station of the AP MLD and the non-AP affiliated station operating as a Group Owner, GO, of the P2P group;
a second Basic Multi-Link IE including information of the AP affiliated station of the AP MLD, and wherein
an MLD ID subfield in RNR IE and Basic Multi-Link IEs is used to indicate whether a reported AP belongs to the first or second BSS.

According to another aspect of the invention, it is proposed a computer program product for a programmable apparatus, the computer program product comprising a sequence of instructions for implementing a method according to the invention, when loaded into and executed by the programmable apparatus.

According to another aspect of the invention, it is proposed a computer-readable storage medium storing instructions of a computer program for implementing a method according to the invention.

According to another aspect of the invention, it is proposed a computer program which upon execution causes the method of the invention to be performed.

According to another aspect of the invention, it is proposed a non-access point, AP, multi-link device, MLD, comprising a first affiliated non-AP station and at least one second affiliated non-AP station, wherein the non-AP MLD is capable of configuring simultaneously the first affiliated non-AP station as a peer-to-peer, P2P, station for communicating with a peer station in a first basic service set, BSS, forming a P2P group and the second affiliated non-AP stations as stations for communicating with an access point in a second BSS.

In some embodiments, the first BSS and the second BSS are not part of a same extended service set, ESS.

In some embodiments, the second affiliated non-AP stations are configured as stations for communicating each with an affiliated AP station of an AP MLD.

In some embodiments, the second affiliated non-AP stations are configured as stations for communicating with a non-MLD AP station.

In some embodiments, the non-AP MLD comprises:
an upper MAC sublayer (424a) common to the first affiliated non-AP station and to the second affiliated non-AP stations;
a first dedicated entity comprising a first lower MAC sublayer (424b) and a first PHY layer (423), the first dedicated entity being dedicated to the first affiliated non-AP station; and
a second dedicated entity comprising a second lower MAC sublayer (424b) and a second PHY layer (423), the second dedicated entity being dedicated to each of the second affiliated non-AP stations.

In some embodiments, a single service access point, SAP, is provided to upper layers.

In some embodiments, data flows of the first BSS and data flows of the second BSS are handled independently in the upper MAC layer.

In some embodiments, the upper MAC sublayer is configured to receive from the SAP indication that an entering data flow belongs to the first BSS, and configured to isolate the entering data flow according to this indication, the indication being one of:
a value of a priority field,
a traffic identifier,
a stream classification service identifier, SCSID, identifying an SCS stream characterized by a TCLAS Element and/or a TCLAS Processing Element,
a local index determined by the SAP, or
an address of the first affiliated non-AP station.

In some embodiments, the non-AP MLD comprises:
a first upper MAC sublayer dedicated to the first affiliated non-AP station;
a second upper MAC sublayer common to the second affiliated non-AP stations;
a first dedicated entity comprising a first lower MAC sublayer (424b) and a first PHY layer (423), the first dedicated entity being dedicated to the first affiliated non-AP station; and
a second dedicated entity comprising a second lower MAC sublayer (424b) and a second PHY layer (423), the second dedicated entity being dedicated to each of the second affiliated non-AP stations.

In some embodiments, the first BSS and the second BSS operates on different channels.

In some embodiments, the first BSS is a wireless-fidelity, Wi-Fi, BSS.

In some embodiments, the Wi-Fi BSS operates a Wi-Fi Direct specification, and wherein the P2P Group Identifier of said Wi-Fi BSS takes the station association identifier (STA AID) value of the first affiliated non-AP station acting as Group Owner.

In some embodiments, the non-AP MLD is configured to provide a multi-link information element to the AP, the multi-link information element providing capacity information for a station to join the P2P group.

In some embodiments, the first affiliated non-AP station being configured to communicate with the peer station on a first channel of the first BSS and the at least one second affiliated non-AP station being configured to communicate with the AP on at least one second channel of the second BSS, the non-AP MLD is configured for:
reporting the P2P group and the first channel, by the at least one second affiliated non-AP station of the non-AP MLD, to the AP MLD.

In some embodiments, reporting the P2P group comprises transmitting a P2P Information Element, IE.

In some embodiments, the P2P IE is transmitted in a P2P Invitation Request frame transmitted on the second channel by the at least one second affiliated non-AP station to the AP MLD to be transmitted to another station connected to the AP MLD.

In some embodiments, the P2P IE is transmitted in a Multi-Link IE of a Probe Request frame.

In some embodiments, the Probe Request frame further comprises a Reduced Neighbour Report, RNR, IE identifying the first non-AP affiliated station operating as a Group Owner, GO, of the P2P group, in addition to the Multi-Link IE including information of the GO, and wherein the RNR IE and ML IE include an MLD ID subfield and a link ID subfield, respectively set to same value but distinct from respective subfield values used for the second BSS.

In some embodiments, the non-AP MLD is further configured for:
receiving the P2P IE, from the AP MLD, in a Probe Response frame or in a beacon frame on the second channel.

In some embodiments, the P2P IE is included in a per-STA profile in a first Basic Multi-Link IE.

In some embodiments, the beacon frame or Probe Response frame further comprise, in addition to the first Basic Multi-Link IE:
a RNR IE identifying the AP affiliated station of the AP MLD and the non-AP affiliated station operating as a Group Owner, GO, of the P2P group;
a second Basic Multi-Link IE including information of the AP affiliated station of the AP MLD, and wherein
an MLD ID subfield in RNR IE and Basic Multi-Link IEs is used to indicate whether a reported AP belongs to the first or second BSS.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical wireless communication system in which embodiments of the invention may be implemented;

FIG. 2 illustrates an example of a multi-link arrangement in accordance with 802.11be;

FIG. 3a illustrates the process of forming a P2P group;

FIG. 3b illustrates such a P2P Concurrent Device that has one MAC entity operating as a WLAN-STA and the second MAC entity operating as a P2P Device;

FIG. 4a shows a schematic representation of a non-AP H-MLD communication device in embodiments of the invention;

FIG. 4b illustrates schematically the architecture of the communication device of FIG. 4a;

FIG. 5 illustrates a block diagram example of a multi-link arrangement in accordance with embodiments of the invention;

FIG. 6 illustrates another exemplary wireless connectivity;

FIG. 7a illustrates a possible implementation for advertising P2P Device operation for a non-AP H-MLD device;

FIG. 7b illustrates an alternative embodiment of a MLO link information element;

FIG. 8 illustrates the main steps of a method for configuring a link for Wi-Fi Direct communication as operated by a P2P affiliated station of an H-MLD in embodiments of the invention;

FIGS. 9 and 10 disclose device architectures representing two reference models of the non-AP H-MLD 400 that may be used in embodiments of the invention;

FIGS. 11a-11c illustrate the process of P2P Invitation procedure for an hybrid MLD according to embodiments of the invention;

FIGS. 12a-12f illustrate the process of advertisement of a P2P group via the infrastructure BSS according to embodiments of the invention;

FIG. 13 illustrates the format of the Reduced Neighbor Report (RNR) information element used in embodiments of the invention.

### DETAILED DESCRIPTION OF THE INVENTION

The invention will now be described by means of specific non-limiting exemplary embodiments and by reference to the figures.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilise different directions to simultaneously transmit data belonging to multiple user terminals. A TDMA system may allow multiple user terminals to share the same frequency channel by dividing the transmission signal into different time slots or resource units, each time slot being assigned to different user terminal. An OFDMA system utilises orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilise interleaved FDMA (IFDMA) to transmit on sub-carriers that are distributed across the system bandwidth, localised FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise a non-access point station (so-called non-AP station).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a non-AP station may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11 be, as illustrated by draft IEEE P802.11be/D2.2 of October 2022, introduce the Multi-Link Operation (MLO) when it comes to MAC layer operation. The MLO allows multi-link devices to establish or setup multiple links and operate them simultaneously.

A multi-link device (MLD) is a logical entity and has more than one affiliated (AP or non-AP) station (STA) and has a single medium access control (MAC) service access point (SAP) to logical link control (LLC), which includes one MAC data service. Besides, the MLD also comprises a single address associated with the interface, which can be used to communicate on the distribution system medium (DSM).

The stations forming the same MLD may be partly or all collocated within the same device or geographically dispersed.

An access point multi-link device (AP MLD) corresponds to a MLD where each station (STA) affiliated with the MLD is an AP, referred to as “affiliated AP” hereinafter.

A non-access point multi-link device (non-AP MLD) corresponds to a MLD where each station (STA) affiliated with the MLD is a non-AP station, referred to as “affiliated non-AP station”.

When referring hereinafter to either an AP MLD or a non-AP MLD, the general term “station MLD” may be used.

Depending on the literature, “multilink device”, “ML device” (MLD), “multilink logical entity”, “ML logical entity” (MLE), “multilink set” and “ML set” are synonyms to designate the same type of ML device.

Multiple affiliated non-AP STAs of a non-AP MLD can then setup communication links with multiple affiliated APs of an AP MLD, hence forming a multi-link channel. This is for instance done through the conventional association procedure: ML Discovery including passive scanning (ML beacons) or active scanning (ML Probe Request and corresponding Response), following by ML Authentication and finally by ML Setup where the non-AP MLD associates with the AP MLD (hence obtained an Association IDentifier, AID) and sets up the ML links for its affiliated non-AP STAs with the APs affiliated with the AP MLD.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

The terms “traffic” and/or “traffic stream(s)” as used herein, are defined as a data flow and/or stream between wireless devices.

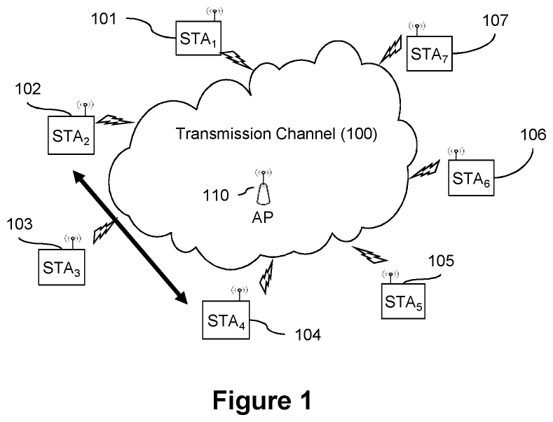

FIG. 1 illustrates a wireless communication system in which several communication station devices 101-107, 110 exchange data frames over a radio transmission channel 100 of a wireless local area network (WLAN), under the management of a central station, namely access point device (AP) 110. Direct communications between STAs can also be implemented without the use of an access point (known as an Ad-hoc mode). The radio transmission channel 100 is defined by an operating frequency band constituted by a single channel, a plurality of channels forming a composite channel, or a plurality of distinct channels (links) forming a multi-link operation.

In the following description, the term “station” or “STA” may be used to describe a non-AP station operating on a given link of 100, which may be a standalone non-AP station or an affiliated non-AP station entity of a non-AP MLD device. Similarly, the term “AP” describes an AP station operating on a given link, which may be a standalone AP station or an affiliated AP station entity of an AP MLD device.

Exemplary situations of direct communications, corresponding to an increasing trend nowadays, include the presence of peer-to-peer (P2P, also known as Direct Link or “DiL”) transmissions in between non-AP stations, e.g. STA 102 and STA 104 as illustrated by FIG. 1. Technologies that support P2P transmissions are for example WiFi-Miracast® or Wireless Display scenario, or Tunneled Direct Link Setup (TDLS). Note that even if P2P flows are usually not numerous, the amount of data per flow may be huge (typically low-compressed video, from 1080p60 up to 8K UHD resolutions).

Each STA 101-107 registers to the AP 110 during an association procedure. During the association procedure, the AP 110 assigns a specific Association IDentifier (AID) to the requesting STA. For example, the AID is a 16-bit value uniquely identifying the STA. When the AP and non-AP STA are respectively an affiliated AP of an ML AP device and an affiliated non-AP of a ML non-AP device, they establishing a ML association wherein an unique AID is assigned to the entire non-AP MLD: all affiliated non-AP STAs are identified by same AID value on their respective operation link.

The stations 101-107, 110 may compete on a given link one against the other using EDCA (Enhanced Distributed Channel Access) contention, to access the wireless medium in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, in the wireless network.

One implementation of such a MU scheme has been for example adopted in IEEE Std 802.11ax-2021 standard, as the Multi-User Uplink and Downlink OFDMA (MU UL and DL OFDMA) procedures.

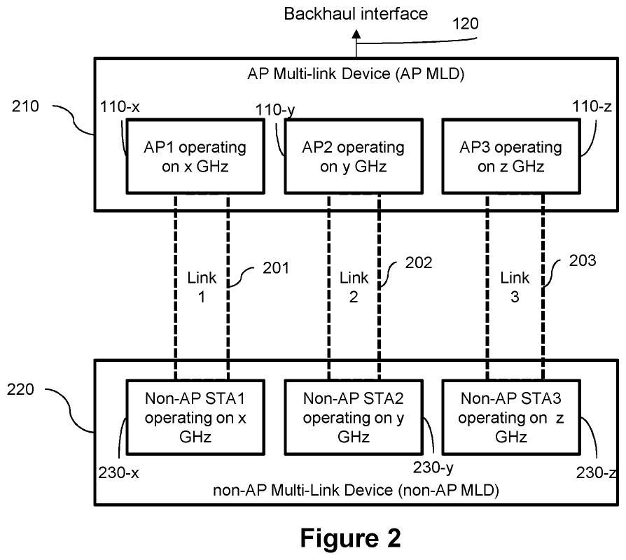

FIG. 2 illustrates a block diagram example of a multi-link arrangement in accordance with 802.11be.

A Multi-Link logical entity or device may be seen as a collection of two or more STAs; each STA operating on a specific link (frequency band) and comes with its own link specific PHY and lower MAC layer.

An “AP multi-link device” (AP MLD) is a multi-link device, wherein each affiliated STA is an AP. A client STA multi-link device (non-AP MLD) is a multi-link device, wherein each affiliated STA is a non-AP STA.

It should be noted that the term “multi-link set” may be used in some descriptions herein, but the scope of embodiments is not limited by this terminology. Other terminology may be used, in some cases, including but not limited to: a multi-link logical entity (MLE), a multi-link AP logical entity (MLE AP), a multi-link non-AP logical entity (MLE STA or non-AP MLE STA), multi-link device (MLD), a multi-link AP device (MLD AP), a multi-link non-AP device (MLD STA or non-AP MLD STA) and/or other.

As illustrated by FIG. 2, multiple APs 110 are included in a multi-link AP logical entity or device 210. In addition, multiple STAs 230 are included in a multi-link non-AP logical entity or device 220.

The APs 110-x, 110-y, 110-z and/or the STAs 230-x, 230-y, 230-z operate in accordance with one or more of IEEE 802.11 a/b/g/n/ac/ad/af/ah/aj/ay, EHT, or another wireless communication standard.

In some embodiments, an affiliated AP 110 may be configured to operate in a frequency band that is different from a frequency band of at least one of the other affiliated APs 110 of the plurality of APs. In some embodiments, the affiliated AP 110 may be co-located with at least one of the other affiliated APs 110 of the plurality of affiliated APs enclosed in the MLE AP 210.

In some embodiments, multiple affiliated APs 110 are collocated in an AP device 210 that supports simultaneous operations to one or more non-AP devices 220. Between the AP 210 device and one non-AP device 220, there are different interfaces related to links 201, 202, 203.

The AP MLD 210 may also be in communication with other systems (e.g. a distribution system (DS) such as a local area network and/or wide band network) via an interface 120, such as a backhaul interface (typically an Ethernet Link).

In MLD operation, simultaneous transmit and receive (STR) operation may be allowed. That is while one link is transmitting another link is receiving. Non-AP MLDs may be STR or non-STR (NSTR).

Recently, 802.11be introduced the concept of non-simultaneous transmit and receive (NSTR) soft access point (AP) multi-link device (MLD). The term NSTR mobile AP MLD is also used. In general, a softAP represents a software enabled AP and implies a software enabling a device which has not been specifically made to be a router into a wireless AP. IEEE 802.11be defines mechanisms to support the operation of a Non-STR AP MLD in release 1 (R1). The mechanisms are limited to instantiate a Non-STR Non-AP MLD as a Soft AP that could utilize all its links under AP-like operation: If a non-AP MLD intends to operate as an AP MLD, this device becomes the soft AP MLD. However, when a non-AP MLD is a non-STR MLD defined in IEEE 802.11 TGbe, it imposes some issues for the soft AP MLD operation due to the restriction that the non-AP MLD cannot transmit and receive simultaneously on the non-STR link pair. This soft-AP MLD is in a mobile device that is typically battery powered. Soft AP is a mechanism allowing a non-AP MLD station to be temporally turned to adopt AP functionality. A soft AP has typically limited capacity compared to a regular AP. The limitation may regard the bandwidth, the number of stations that can connect to the soft AP. In a non ML context, an example of soft AP is the connection sharing functionality of modern smartphones. It is to be noted that a soft AP MLD has all its affiliated station adopting the AP behaviors.

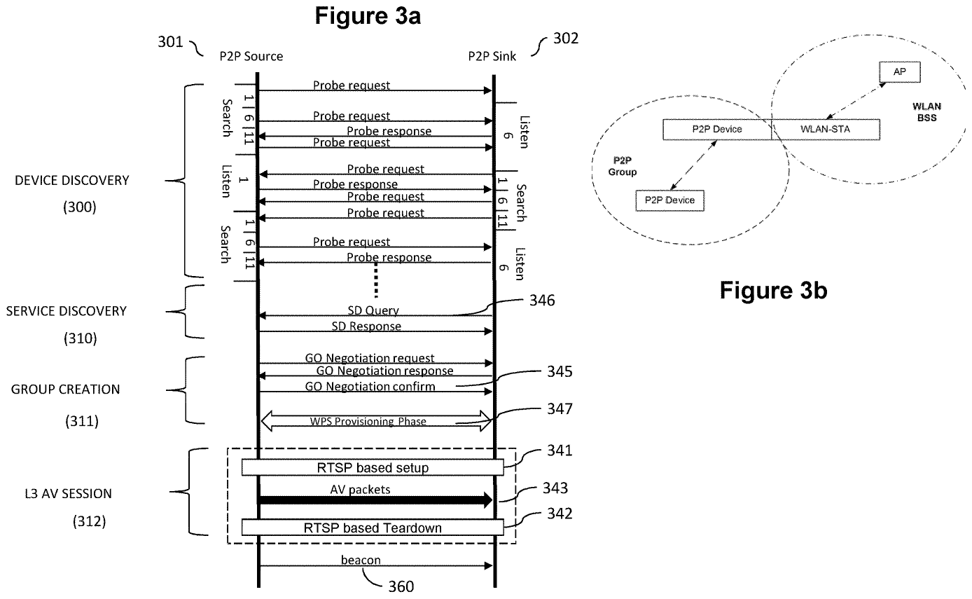

FIGS. 3a and 3b illustrate Wi-Fi Direct modes of operation.

Wi-Fi Direct is a direct communication technology that may enable devices to be easily connected with each other without the AP basically required in a conventional WLAN system. According to Wi-Fi Direct, devices may be connected to each other without a complicated establishment procedure (device-to-device connectivity). Wi-Fi Direct enables Wi-Fi devices to connect directly to each other, making it simple and convenient to print, share, sync, play games, and display content to another device. Wi-Fi Direct devices connect to one another without having to join a traditional home, office, or public network. Devices can make a one-to-one connection, or a group of several devices can connect simultaneously.

As a difference to soft access point (AP) mode discussed previously in the context of 802.11 (the mobile electronic device serves as an AP, which allows other clients to access to), the Wi-Fi operating peer-to-peer (P2P) mode refers to a mode where each party has the same capabilities and either party can initiate a communication session. More generally, a P2P Device is a Wi-Fi Direct device that is capable of acting as both a P2P Group Owner and a P2P Client. The P2P Client role implements non-AP STA functionality. The P2P Group Owner has a role which is similar to the AP role providing BSS functionality and services for associated Clients (P2P Clients or Legacy Clients).

Direct device to device connectivity was already possible in the original IEEE 802.11 standard by means of the ad-hoc mode of operation. However this ad-hoc mode has never been able to mark its presence in the market due to several drawbacks or limitations in the requirements, e.g., lack of efficient power saving support or extended QoS capabilities.

Wi-Fi Direct devices has been designed in the context of 802.11a, g, or n. Therefore, Wi-Fi Direct does not benefit from recent 802.11be technology, such as multi-link operation.

FIG. 3a illustrates the process of forming a P2P group. A Wi-Fi Direct connection is mainly performed through three processes including a device discovery, a service discovery and group establishment.

Device discovery: the device discovery process 300 is required when Wi-Fi P2P devices, for example, a first and a second P2P device (301,302), recognize each other to configure a connection to establish the Wi-Fi P2P group. In this phase, a device will alternate between a listen state and a search state. A first P2P device searches for neighboring Wi-Fi P2P devices by repeatedly performing channel scan of IEEE 802.11 channels by listening to the social channels, defined as channel 1, 6 and 11 in the 2.4 GHz band, and searching these channels for a predetermined time period. A basic operation of the device discovery process performed during the Wi-Fi P2P group establishment is implemented by exchanging a probe request message and a probe response message of an IEEE 802.11 MAC protocol. These exchanges enable the P2P stations to discover each other on a nearby environment.

Service discovery: the service discovery 310 is performed after the device discovery process to provide a function of exchanging information on services that each P2P device can support. That is, each P2P device may identify a supportable service protocol, a service and the like through exchange of a request message and a response message (346). P2P Devices thus exchange queries to discover the set of available services and, based on this, decide whether to continue the group formation or not.

Group generation: a group owner (GO) negotiation process 311 is performed by a three-way exchange 345 of a GO negotiation request, a GO negotiation response, and a GO negotiation confirm frame, whereby the two devices agree on which device will act as P2P GO, the other one acting as a client of the GO, and on the channel where the group will operate, which can be, for example, in the 2.4 GHz or 5 GHz bands.

Security provisioning 347 starts after discovery has taken place and, if required, the respective roles have been negotiated upon forming the group.

Once the P2P Group is established, new P2P devices can discover and join the group using active or passive scanning mechanisms like the ones used in traditional Wi-Fi networks. Like a traditional AP, a P2P GO announces itself through beacons (360), and has to support power saving services for its associated clients. The P2P GO is also required to run a Dynamic Host Configuration Protocol (DHCP) server to provide P2P Clients with IP addresses (not represented in the figure).

Upon successful Wi-Fi Direct Connection Setup between devices, the devices attempt to establish an Audio-Video Session 312. Communication within a P2P Group established shall employ WPA2-Personal security.

An AV control session, steps 341-342, initiates a Transmission Control Protocol (TCP) connection, wherein one of the P2P devices acts as a P2P Sink (e.g. 302) and the second as a P2P Source (e.g. 301) with regards to the AV data flow. The P2P Source typically plays the TCP server role. The protocol running on the Control Port is a Real Time Streaming Protocol (RTSP).

According to standard, a Real-time Transport Protocol (RTP) or a Real-time Transport Control Protocol (RTCP) may be used as the data path for the AV data session 343; and a RTSP may be used as a control path for the AV control session. Audio/Video elementary streams generated by the P2P Source shall be packetized using a MPEG2-TS container format and encapsulated by RTP/UDP/IP headers prior to 802.11 packetization and transmission.

Some devices certified under the Wi-Fi Direct program support connections to both an infrastructure network and Wi-Fi Direct group at the same time (e.g. a laptop may support an infrastructure connection while also belonging to a Wi-Fi Direct-certified group). Simultaneous connection to a Wi-Fi Direct group and an infrastructure network is an optional feature. To do so, the WiFi chip does not use only one interface for wireless communication, but dual MAC products that support two interfaces are used.

FIG. 3b illustrates such a P2P Concurrent Device that has one MAC entity operating as a WLAN-STA and the second MAC entity operating as a P2P Device. A P2P Group may operate in the same or different operating class and channel as a concurrently operating WLAN BSS.

Implementation of multiple MAC functionality is out of scope of the Wi-Fi P2P specification. Practically, as stated above, two 802.11/Wi-Fi chipsets are used, which is a costly and static architecture. Presently, P2P may be mainly used for semi-static communication such as remote printing, photo sharing, screen mirroring, etc.

However, due to generalization of Wi-Fi devices and location based services, P2P availability is gradually increased. P2P devices constituting the Wi-Fi Direct group may be changed at any time due to movement of the P2P devices, and a new Wi-Fi Direct group may be dynamically generated or deleted within a short time.

The Wi-Fi Direct standard lacks a way to dynamically implement concurrent links on recent chipsets like 802.11be ones.

With the increasing number of operating bands/channels including those of the recent 6 GHz band, traditional scan (active or passive) of the channels takes too much time.

Furthermore, specific to Wi-Fi Direct, the P2P GO usually stays on the operating channel of its P2P Group once the latter is established. This means that, by failing to switch back to the social channels, it becomes complicated for new P2P devices to discover and thus to join the P2P Group.

It comes that the known discovery mechanisms are not sufficient to provide efficient network communication in wireless networks, in particular to discover ad hoc networks, including P2P groups, to promote direct device-to-device connectivity.

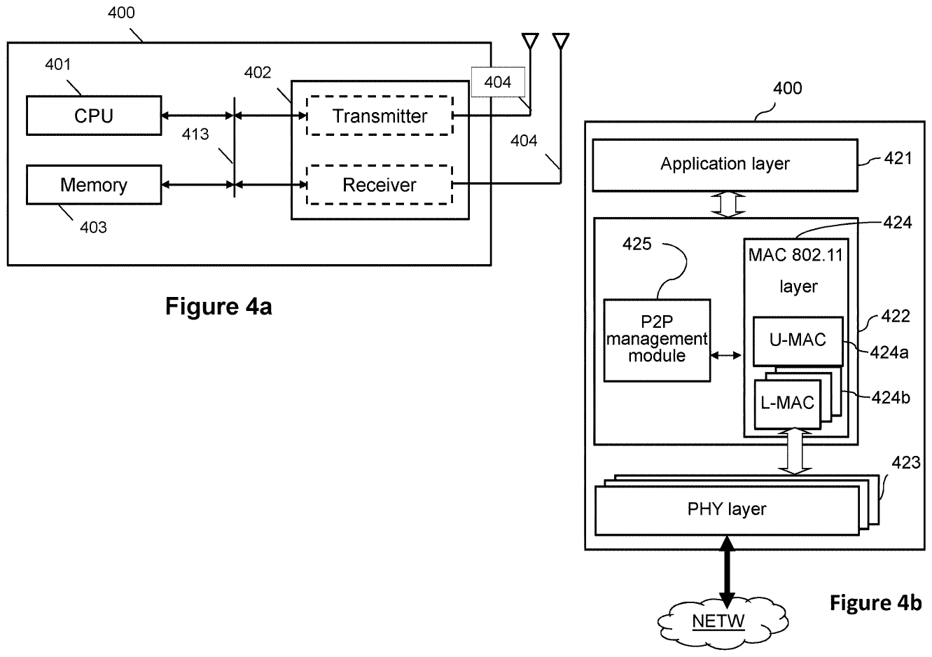

FIG. 4a schematically illustrates a non-AP H-MLD communication device 400, embedding a plurality of non-AP stations 110 of a radio network NETW, configured to implement at least one embodiment of the present invention. The communication device 400 may preferably be a device such as a micro-computer, a workstation or a light portable device. The communication device 400 comprises a communication bus 413 to which there are preferably connected:
a central processing unit 401, such as a processor, denoted CPU;
a memory 403 for storing an executable code of methods or steps of the methods according to embodiments of the invention as well as the registers adapted to record variables and parameters necessary for implementing the methods; and
at least one communication interface 402 connected to a wireless communication network, for example a communication network according to one of the IEEE 802.11 family of standards and/or Wireless-Fidelity (Wi-Fi) specifications, via transmitting and receiving antennas 404.

Preferably the communication bus provides communication and interoperability between the various elements included in the communication device 400 or connected to it. The representation of the bus is not limiting and in particular the central processing unit is operable to communicate instructions to any element of the communication device 400 directly or by means of another element of the communication device 400.

The executable code may be stored in a memory that may either be read only, a hard disk or on a removable digital medium such as for example a disk. According to an optional variant, the executable code of the programs can be received by means of the communication network, via the interface 402, in order to be stored in the memory of the communication device 400 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 4b is a block diagram schematically illustrating the architecture of the communication device 400, adapted to carry out, at least partially, some embodiments of the invention. As illustrated, device 400 comprises a physical (PHY) layer block 423, a MAC layer block 422, and an application layer block 421.

The PHY layer block 423, here a plurality of 802.11 standardized PHY layer modules, has the task of formatting, modulating on or demodulating from any 20 MHz channel or composite channel. The PHY layer thus sends or receives frames over the radio medium NETW, such as 802.11 frames. These frames may be for instance medium access trigger frames to reserve a transmission slot, MAC data and management frames based on a 20 MHz width to interact with legacy 802.11 stations and with legacy Wi-Fi Direct specification, as well as of MAC data frames of OFDMA type having smaller width than 20 MHz legacy (typically 2 or 5 MHz) to/from that radio medium.

The MAC layer block or controller 422 preferably comprises a Multi-Link MAC 802.11 layer 424 implementing conventional 802.11 MAC operations. It may comprise additional block 425 for carrying out, at least partially, embodiments of the invention. The MAC layer block 422 may optionally be implemented in software, which software is loaded into RAM 403 and executed by CPU 401. The ML MAC 802.11 layer 424 may implement an Upper-MAC stack along with a series of Lower-MAC modules.

Preferably, the additional block 425, referred to as P2P management module for performing multi-link operations for P2P traffic streams, implements part of embodiments of the invention.

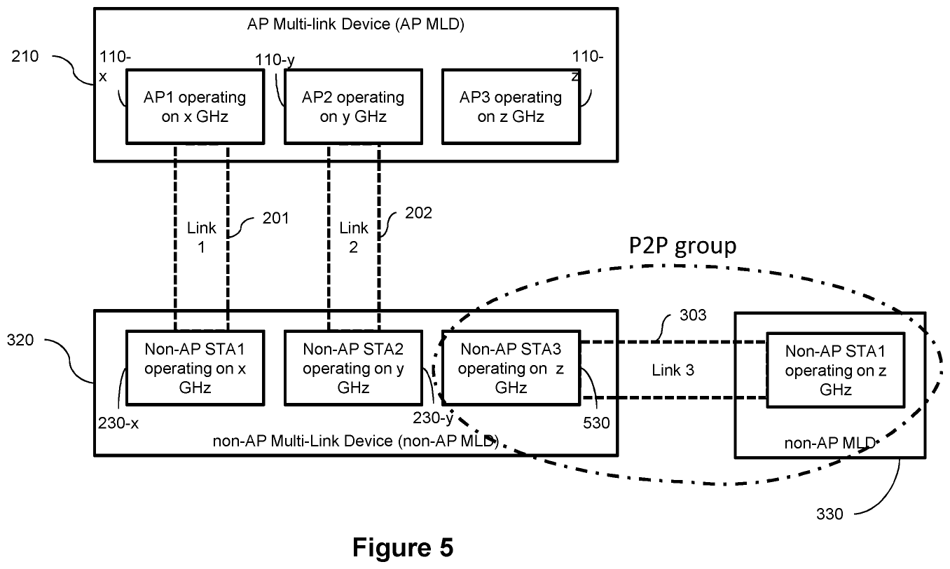

This block performs the operations of the methods illustrated on FIGS. 5-13 depending on the role of the communication device 400, P2P Device client or Group-Owner peer.

MAC 802.11 layer 424 and P2P Link management module 425 interact one with the other in order to establish and process accurately communications over a P2P Link in between multiple MLD non-AP stations forming a P2P group according to embodiments of the invention. The MAC 802.11 layer 424, may comprise a single upper MAC layer 424a handling a plurality of lower MAC layer modules 424b.

On top of the FIG. 4b, application layer block 421 runs an application that generates and receives data packets, for example data packets such as a video stream. Application layer block 421 represents all the stack layers above MAC layer according to ISO standardization.

FIG. 5 illustrates a block diagram example of a multi-link arrangement in accordance with embodiments of the invention. This typically illustrates a method of communication in a wireless network comprising a multi-link access point AP MLD 210, and the wireless network comprising at least a first non-AP MLD 320 and a second non-AP station 330, which may be, for example a legacy station.

The method comprises:
establishing a first connection illustrated by the two links 201, 202 between the first non-AP MLD 320 and the AP MLD 210;
establishing a second connection illustrated by link 303 between the first non-AP MLD 320 and second STA 330;
transferring data between the first non-AP MLD 320 and the AP MLD 210 through an infrastructure BSS established on the first connection; and
transferring data between the first non-AP MLD 320 and the second STAs 330 through a P2P group established on the second link.

It should be noted that the establishment of the first and second connections may be done in any order or simultaneously.

In summary, in embodiments of the invention, it is provided enhancement of 802.11be multi-link operation, consisting in enabling ‘P2P device’ operation above an affiliated STA 530 of a non-AP MLD 320, the other affiliated STAs remaining non-AP STAs. Therefore, the non-AP MLD STA 320 is associated with two different networks, one being a P2P group. Each affiliated STA is associated with one of the two networks. In other terms, some of the affiliated stations are connected to a different network, forming a P2P group, while the other ones are connected to a regular BSS (infrastructure BSS administrated by an AP MLD).

The term Hybrid MLD (H-MLD) is used for identifying device 320 according to embodiments, wherein affiliated STAs are linked with two or more distinct BSS entities. That means the affiliated STAs of the H-MLD do not communicate with affiliated STAs of a same MLD, they belong to different networks and bands of operation. As further disclosed, the data communication is separated in between those distinct P2P and infrastructure networks.

As will become apparent, the P2P connection can be dynamically created by the Hybrid MLD, without support from the AP MLD. In embodiments, more than one P2P connection can be established, meaning that an affiliated station is connected to a first P2P group while another affiliated station is connected to a second P2P group. According to a second aspect, discovery of such “P2P communication groups” may be made easier by the AP MLD.

The illustration illustrates a non-AP STA 330 which is a multi-link station. This is not limitative, as it could be a legacy non-AP station, a 802.11be non-AP MLD with more than one affiliated non-AP STAs, or any H-MLD device 400 according to embodiments.

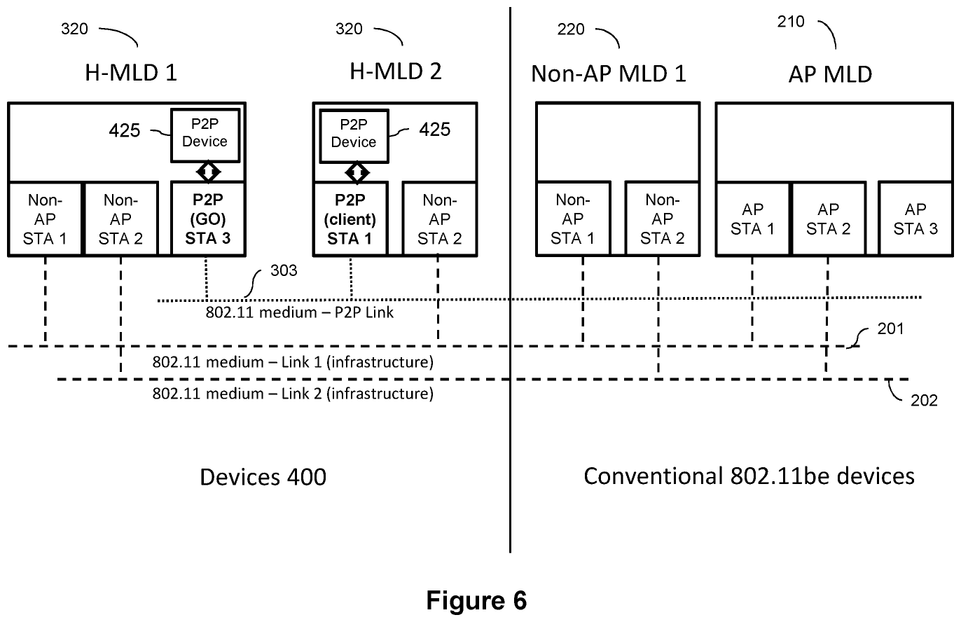

FIG. 6 illustrates another exemplary wireless connectivity.

Traditionally, a non-AP STA associates with an AP to start its operations: 802.11be provides multi-link setup between a multi-link non-AP STA 220 and an AP MLD 210 to achieve the functionalities of “traditional association” under the new multi-link framework. Capability for different bidirectional links, ex. configuration of the link, AP capability, non-AP STA capability, can be exchanged through multi-link setup.

As a result, at least one link 201 is established in between the non-AP MLD 1 220 and its AP MLD 210.

Concerning the H-MLDs 320 (H-MLD 1 and H-MLD 2), at least one link 201 is also established in between each H-MLD and the AP MLD 210. In addition, according to embodiments, at least one P2P link 303 is also established outside the management of the AP MLD 210, in between each H-MLD 1 and 2 forming a P2P group.

Among set of the established links, Links 201, 202 serve for infrastructure operations and Link 303 serves for direct P2P operations.

In some embodiments, the links 201 and 303 can share the same frequency operation.

Advantageously, Link 303 does not interfere with Links 201, 202: the medium access is separated and no issue pertains due to the heavy P2P traffic. In addition, as this link operates outside the network infrastructure, the AP MLD is liberated from management of P2P flow.

In some variants, the Hybrid-MLD may associate with any single-link AP (that is to say non-multi-link capable, as former technologies prior to 802.11 be). The H-MLD 320 is still able to instantiate a P2P link in that context.

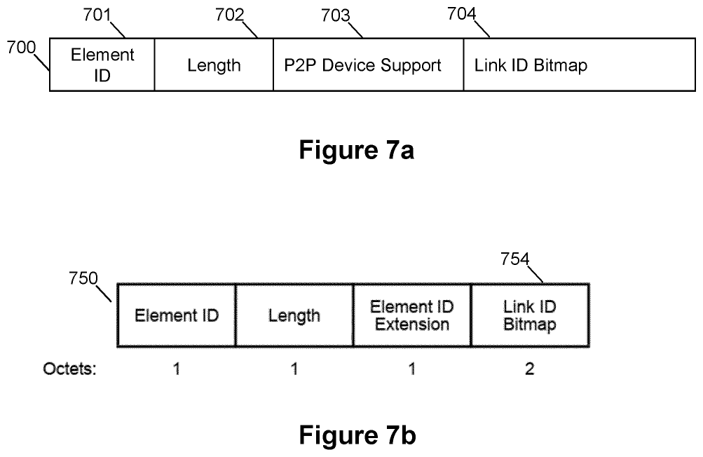

FIG. 7a illustrates a possible implementation for advertising P2P Device operation for a non-AP H-MLD device 400, in a management frame such as a beacon frame or a probe response frame. As shown, a dedicated information element, IE, is used for the advertising. Information element are widely used, meaning the dedicated IE can be supplemental to existing IEs in the management frame.

The information element, or IE, is a type-length-value (TLV) item. Of course, any combination of one or more of those parts is possible. For instance, the length value can be omitted if it is fixed and known by all parties.

The element ID subfield 701 identifies the IE as providing P2P Device activation requirements. It may take a value in the range [245-254], so far reserved in the 802.11 standard. For the purpose of illustration, value 247 may be chosen in some embodiments.

The Length subfield 702 indicates the number of bytes forming the IE including the element ID subfield and the Length subfield.
bit 703 advertises whether the non-AP station is capable to activate a P2P Device in complement to the traditional infrastructure BSS, for example with a value set to 1, or whether it does not, for example with a value set to 0.

The Link ID Bitmap subfield 704 indicates the links to which the P2P Device operation for a STA affiliated with the non-AP MLD applies.

Preferably, as illustrated here below, the indicated links of the bitmap correspond to those of the AP MLD. But this is not limitative, the H-MLD device 400 may instantiate links different from the AP MLD.

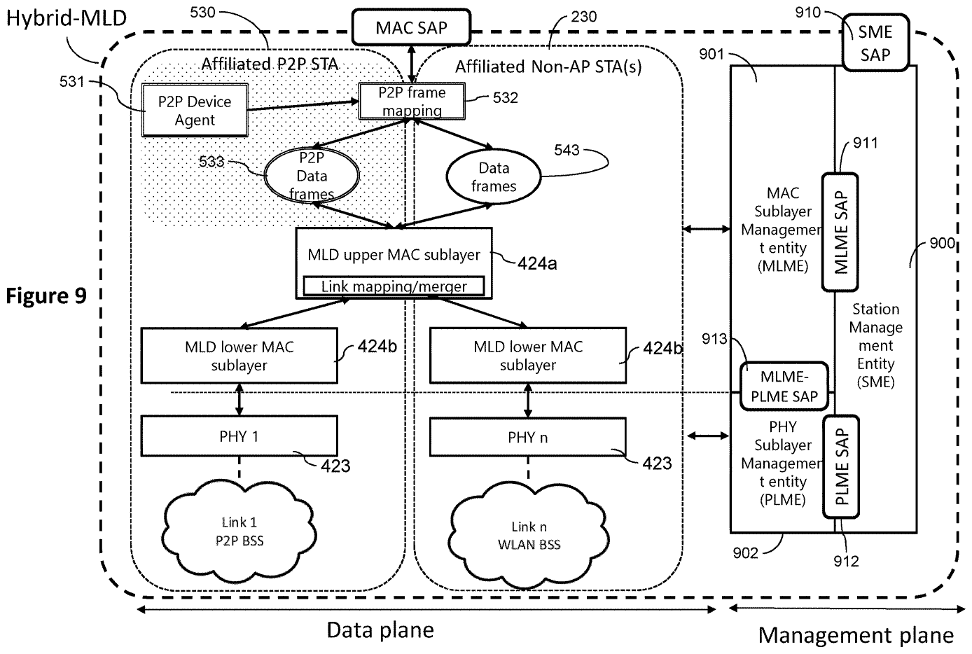

FIG. 9 illustrates a reference model of an hybrid MLD. It will be described in detail later. Some aspects of 802.11 Management Layer Structure are now explained in relation with FIG. 9.

The MAC layer and the PHY layer conceptually include management entities called MAC sublayer management entity 901 (MLME) and physical layer management entity 902 (PLME), respectively. These entities provide a layer management service interface that operates a layer management function.

In addition, an SME 900 (Station Management Entity) is present within each 802.11 device. The SME is a layer independent entity that may be viewed as residing in a separate management plane.

The MLME and the SME interact in various ways. For example, the entities may interact by exchanging GET/SET primitives. The primitive means a set of elements or parameters related to a specific object. “XX-GET.request” primitive is used for requesting the value of the given management information base (MIB) attribute. “XX-GET.confirm” primitive is used for returning the appropriate MIB attribute value if status is “success,” otherwise returning an error indication in the Status field. “XX-SET.request” primitive is used for requesting that the indicated MIB attribute be set to the given value. If this MIB attribute implies a specific action, this requests that the action be performed. And, “XX-SET.confirm” primitive is used such that, if status is “success,” this confirms that the indicated MIB attribute has been set to the requested value, otherwise it returns an error condition in the status field. If this MIB attribute implies a specific action, this confirms that the action has been performed.

Also, the MLME and the SME may exchange various MLME_GET/SET primitives through MLME Service Access Point 911 (MLME_SAP). Also, various PLME_GET/SET primitives may be exchanged between PLME and SME through PLME_SAP 912, and may be exchanged between the MLME and PLME through MLME-PLME_SAP 913.

After correlation of lower-layer MLME and PLME events, the SME might synthesize indications to higher layer entities through the SME SAP 910. Other aspects of the reference model illustrated by FIG. 9 will be detailed later.

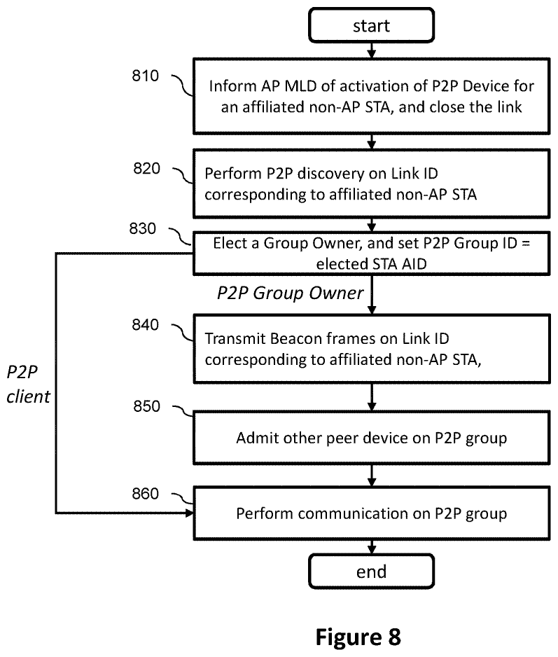

FIG. 8 illustrates the main steps of a method for configuring a link for Wi-Fi Direct communication as operated by a P2P affiliated station of an H-MLD in embodiments of the invention.

In a step 810, the hybrid MLD 400 informs the AP MLD of the activation of P2P device capability of an affiliated non-AP station and close the corresponding link to the AP MLD.

A Hybrid non-AP MLD, as most WLAN connected devices, comprises a management information base for storing a set of parameters playing a role in the behaviors of the device. Embodiments provide a specific capability which is specified in the dot11StationConfigTable in the local management information base (MIB) of the H-MLD, which serves as configuration interface for upper layers.

As example, a Hybrid non-AP MLD is a non-AP MLD which sets dot11P2PDeviceMLDImplemented to true. This attribute, when true, indicates the ability of the EHT STA to support the P2P Device multi-link operation on one of its affiliated station for multi-link operation. If the attribute is false, the station does not support P2P Device multi-link operation.

This information has also to be advertised on the wireless medium.

As example, the EHT Capabilities element contains a number of fields that are used to advertise the EHT capabilities of an EHT STA. Typically, the included EHT MAC Capabilities Information field can be amended for the support of P2P Device according to embodiments. A subfield “P2P Device in MLD Support” indicates whether an affiliated STA of the non-AP MLD can be activated as P2P Device, is supported. This capability is reserved for an AP MLD. For a non-AP MLD STA, when previous MIB entry is set, the subfield is set to 1 to indicate that the non-AP MLD STA is capable of having at least one of its affiliated STA acting as a P2P Device. Set to 0 otherwise.

The EHT Capabilities element, as amended, is further declared by the station during the association procedure with the infrastructure BSS in such a way the AP may decide whether to authorize or refuse the requested association based on the declared capabilities. This may allow the centric AP MLD to determine which stations have the P2P Device capability and direct them to operate on same links to facilitate the discovery process between each other.

Other option provides a specific P2P Device capability (refer to element 700, FIG. 7a), indicating the Link ID used for establishment.

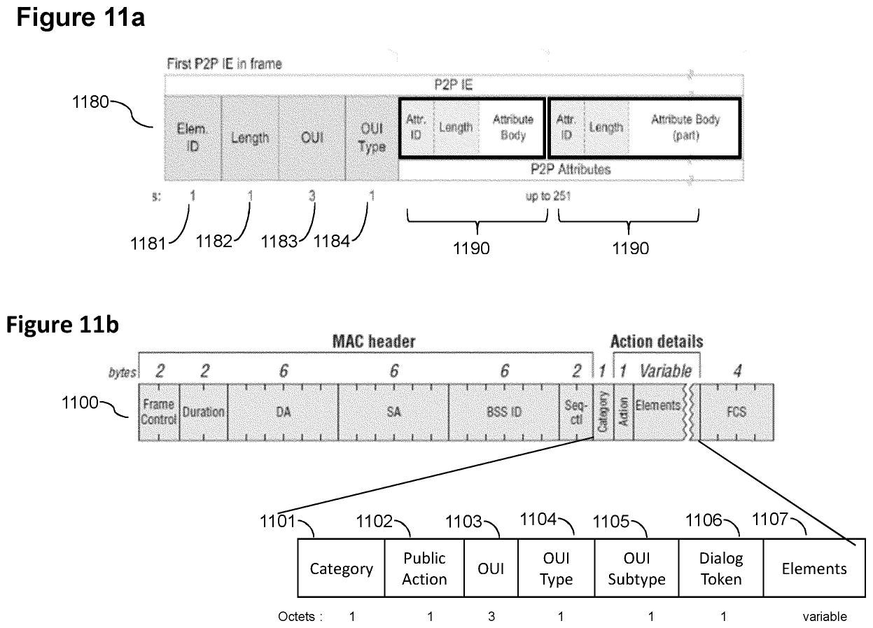

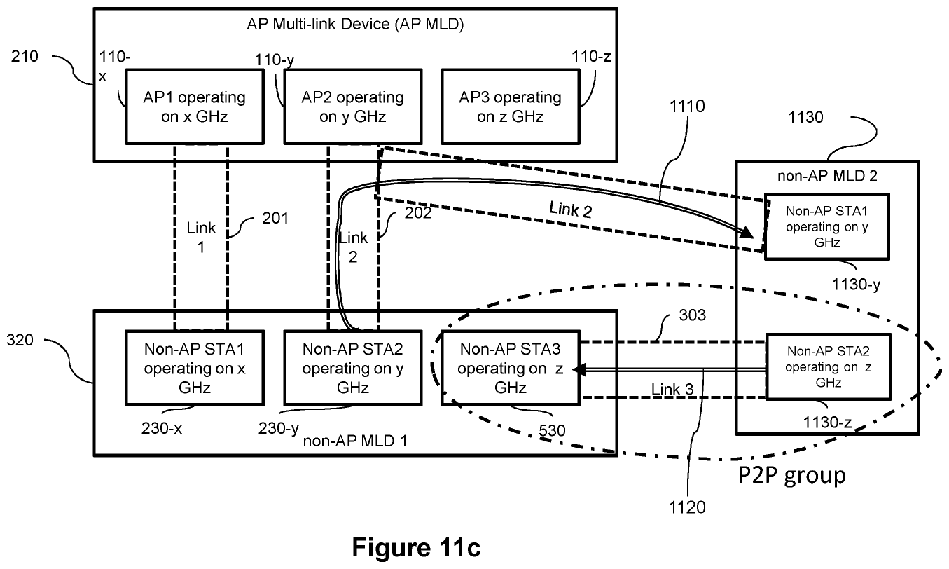

Other options are further provided through FIG. 11 and following ones.

To activate the P2P Device operation, the MLME-START.request requests that the MAC entity starts a new P2P Device service, through EHT Capabilities element or P2P Device capability, along with a link ID indication.

The link ID, as indicated by the non-AP STA and specified in context of the AP MLD, provides a channel, named the Listen Channel, where the P2P device discovery will occur.

Further, the H-MLD device 400 has to perform ML Reconfiguration operation, such that the link corresponding to Link ID is closed with regards to infrastructure use (AP MLD). One possibility consists in the multi-link (re)setup procedure between the non-AP MLD 400 and the AP MLD, that is completed through the exchange of (Re)Association Request and (Re)Association Response frames. Other simpler and more dynamic possibility is that the removal may consist in updating a TID-to-Link mapping with no TID mapped onto the intended link.

Note that the AP MLD is free to keep or not its own activity on the indicated link used for P2P operations.

In a step 820, the H-MLD device performs a discovery on the dedicated link. The P2P device enables “P2P Discovery” phase to quickly find each other and form a P2P connection on the intended link. FIG. 11 and following provide enhancements for the P2P discovery according to embodiments. In short, those enhancements deal with fast discovery of capabilities and intended link for operating P2P communication.

One major action of this phase is the Device Discovery, which uses Probe Request and Probe Response frames to exchange device information on the desired link.

Compared to usual P2P discovery, there is no need to perform scanning on several channels, as the link ID precises the channel to be used, which serves as common channel to enable communication.

In a step 830, a step of group formation occurs.

When a P2P Device 400 discovers another P2P Device 400 with which it intends to connect, it may start the Group Formation Procedure on the intended link ID.

Typically, Group Owner Negotiation is performed by sending the “GO Negotiation Request” frame. In this frame, among parameters of interest, the Channel List attribute shall indicate only the channels of the Link corresponding to Link ID, as single Operating Channel of the P2P Group.

In addition, Wi-Fi Direct specifies that the P2P Group Owner shall assign a globally unique P2P Group ID for each P2P Group when the P2P Group is formed and this shall remain the same for the lifetime of that P2P Group. Embodiments thus envisages that the station AID (obtained by the non-AP MLD during association with the AP MLD) is used as P2P Group ID.

This is also advantageous as the station AID is already known by the other stations of the infrastructure BSS, in contrary to the individual MAC address of each affiliated stations of device 400, such MAC address which may serve as BSSID for the Group Owner BSS.

The P2P direct link being established, the P2P device acting as client will go directly to step 860, whereas the Group Owner performs a step 840 used to send beacon frames and a step 850 where other P2P devices may be admitted in the P2P group.

For beacon frames issued by GO, the TSF timer to be set for the P2P link is preferably the same as the value indicated in beacon frames received from AP MLD for the infrastructure links.

Note that a searching P2P Device discovers a P2P Group Owner in the Scan Phase through received Beacon, or Probe Response frames. As the used link for P2P group is (preferably) one specified by AP MLD, a searching Device 400 operating in the Link ID should be aware, due to those received beacon frames, that the P2P Group Owner has started its operation, and thus may try to join the P2P BSS.

In a step 860, communication within the P2P group may start.

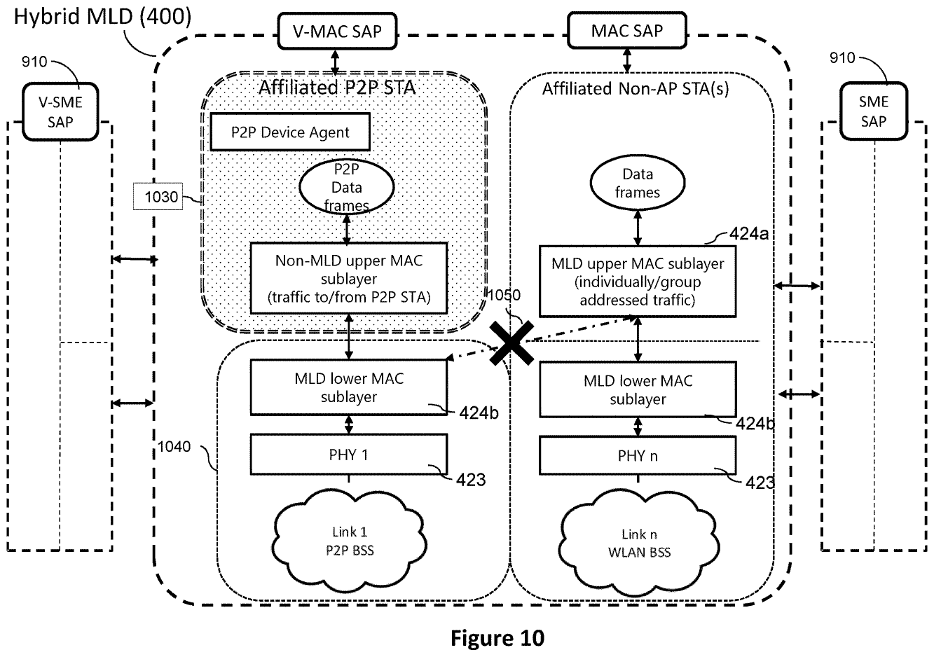

P2P devices can communicate, for example by streaming content, by using the direct link session of the Link. In embodiments as disclosed here below, rules for traffic separation may be exchanged in between the two peers before data communication is started as illustrated by FIG. 9. In variant, all traffic in between peers are conducted via the P2P group Link as illustrated by FIG. 10.

Resulting from the proposed embodiments, the H-MLD 400 is configured to simultaneously transmit different MSDU units to client stations of different extended service sets (ESS), stations in the P2P group or the AP MLD. This is because all APs affiliated with the same AP MLD are members of the same ESS and are connected to the same Distributed System. As a result, all APs affiliated with the same AP MLD shall advertise the same SSID.

On the contrary, the P2P Group is detached from the AP MLD's ESS, and the SSID field has a single SSID prefixed by “DIRECT-” and provides one security domain.

FIGS. 9 and 10 disclose device architectures representing two reference models of the non-AP H-MLD 400 that may be used in embodiments of the invention.

The two architectures are intended to be compatible with Wi-Fi direct or an upgrade of Wi-Fi Direct. An upgrade is likely necessary as current version of Wi-Fi Direct was specified based on 802.11n and does not consider newer multi-links devices. Reference models presented here below provides fully independent and simultaneous P2P group and WLAN operations.

For simplicity, FIG. 9 illustrates a reference model comprising two links, one P2P and one infrastructure, while in general, an MLD can support more than two infrastructure links and the H-MLD 400 may support more than one P2P links.

In that reference model, the SME coordinates the management of multiple MAC sublayers and corresponding PHY layers. Preferably, the model keeps the classical 802.11be reference model where a common MAC SAP and MLME SAP, SAP standing for Service Access Point, are used to control the common Upper MAC and various low MAC and PHY entities forming the affiliated STAs.

When instantiated by the SME, the affiliated P2P STA 530 will activate several block features for P2P Traffic differentiation, above the upper MAC component 950 but still inside the H-MLD 400.

In the present case, the H-MLD device 400 still operates in the infrastructure BSS but instantiates a P2P group for the sake of improved communication towards a P2P peer. Therefore, the entering data traffic is addressed to the same recipient device, and shall belong to the same VLAN ID when passing via the MAC SAP, whether it is P2P data traffic or WLAN data traffic.

The low level mechanisms occurring in MLD upper MAC sublayer 424a, MLD lower MAC sublayers 424b and PHY sublayers 423, allowing operation over multiple links remain standard. We recall that the MLD upper MAC sublayer performs functionalities that are common across all links, and the MLD lower MAC sublayer performs, typically medium access, functionalities that are local to each link.

A new block called P2P Device Agent 531 is also present, it aims at allowing a pair of H-MLDs 400 to discover, synchronize, (de)authenticate, (re)associate, disassociate, and manage resources with each other on the targeted P2P link. This agent can be partially, as later discussed, or entirely part of P2P affiliated STA 530, and can be activated through the SME SAP 910 in order to control the data plane.

During transmission, an MSDU from the MAC SAP goes through P2P frame mapping block 532, before being stored in appropriate transmission or reception buffers 533 (new buffer dedicated to P2P data) or 543 (legacy buffer). This advantageously attributes independent Block Acknowledgment sessions to regulate the transmission, P2P transmission on one hand, WLAN transmission on another hand.

The P2P frame mapping 532 directly catches MSDUs from upper layer, in order to route then to appropriate buffer and provide appropriate sequencing.

An individually addressed data or management frame is intended for a given affiliated STA for wireless transmission, therefore it is mandatory to discriminate traffic among intended affiliated STAs. Various non limitative means may be contemplated to perform in-data traffic separation:

Use of Traffic identifier (TID)-to-link mapping is a first possibility for discriminating the incoming traffic between P2P traffic and WLAN traffic. IEEE 802.11be defines a directional-based TID-to-link mapping mechanism among the setup links of a MLD. This mechanism allows mapping a TID to one or more links. The frames belonging to the TID are sent on the mapped link(s). Such traffic separation can aid latency sensitive traffic flow by assigning a high-volume, latency tolerant traffic flow to a subset of links while mapping latency sensitive flows to all links. This is the role of “Link mapping (tx) and merger (rx)” block inside the MLD upper MAC 424a.

The P2P frame mapping 532 provides a new use of TID-to link mapping, that aims to separate infrastructure and P2P UL/DL flows.

By default, after the multi-link setup, all TIDs are mapped to all setup links. A dedicated TID value may be reserved for P2P data. The P2P link setup should include the TID-to-link mapping re-negotiation when TID-to-link mapping is supported by both MLDs.

Optionally, a higher set of TID value can be dedicated for P2P traffic (e.g. 8-15 for P2P traffic). Such values are referred to as “Traffic Stream Identifier”, TSID, values defined in the 802.11e standard. The Traffic specified by such TSID value may be characterized in a TSPEC element included within an ADDTS Request/Response frames. In other word, the peers perform admission control for the traffic into the P2P group based on this TSID. It is to be noted that the admission control may be limited to identification of a given traffic but not to its QoS characteristics, like for example minimum data rate, mean data rate, and delay bound.

Another possibility is to use the Stream Classification Service (SCS) mechanism that allows a non-AP MLD to define and advertise the AP MLD of a local traffic stream identified with an SCS identifier, SCSID. In short, the SCS mechanism aims to differentiate between separate traffic streams within the same access category or the same TID. According to 802.11be, the TCLAS Elements and the TCLAS Processing Element describe the criteria for traffic classification to apply to identify the data or MSDUs forming the corresponding SCS stream. Therefore, the P2P Device Agent may establish an SCS stream with its peer non-AP MLD indicating the traffic separation rules used to discriminate data for transport over the P2P group of a given Link.

Another mechanism that may be used is the QoS Map element, transmitted in between peers (e.g. QoS Map Configure frame) and that provides the mapping of higher layer quality-of-service constructs to User Priorities for transmission. This element maps the higher layer priority from the DSCP field used with the Internet Protocol to User Priority. This mechanism results into a TID allocation allowing to identify the P2P traffic.

In embodiments, Link mapping/merger block of MLD Upper MAC 424a may be enhanced to support link switching according to SCSID and TID. In variant, any MMPDU issued from the P2P device agent 531 or data frame stored in the P2P dedicated transmission buffer 533 includes an MLO Link Information element 750, illustrated by FIG. 7b, that identifies the intended link(s) for transportation.

According to 802.11be specification, the MLO Link Information element identifies the intended link(s) of the MMPDU that carries the element. This element may also be adapted for data frames. In the present case, the Link ID Bitmap field 754 indicates only one link, namely the P2P link, where the intended peer STAs are operating on.

In embodiments, the P2P Device Agent 531 and P2P frame mapping 532 can be partially implemented in higher layer, typically the Logical Link Control, LLC, sublayer (not illustrated), over the MAC layer. Those can be seen as software implementation in the network stack, and interact via the SME SAP to activate the modules 531/532 in the MAC layer. Concerning the P2P frame mapping 532, the tagging function may be easily performed at the LLC layer, consisting in tagging (TID, SCSID) data prior to send them to MAC SAP interface.

FIG. 10 illustrates another example of reference model of the architecture of an H-MLD device. In this approach, the P2P Device function is performed by a virtual P2P STA.

The H-MLD device 400 sets up at least one virtual P2P client. In the present case, a new Upper MAC 1030 is instantiated for that purpose. It is distinct from the Upper MAC (424a) common to the different affiliated non-AP STAs associated with AP MLD.

The virtual P2P device is enabled by a combination of software and hardware. For example, software modules may control one of the low-network interfaces to function as a P2P device in addition to the other affiliated STAs acting as regular non-AP STAs.

The device 330 is configured as a virtual P2P device 1030, linked with a traditional Low-MAC/PHY 1040. In embodiments, a low entity, name given herein to the lower MAC sublayer and its associated PHY layer, 1040 is detached from the infrastructure operations, as illustrated by the cross 1050, in order to dedicate the P2P link to P2P group.

Each MAC sublayer, the one dedicated to the P2P virtual station and the one dedicated to regular WLAN operation, has a separate MAC SAP and SME SAP 910 as illustrated. A MAC SAP together with its corresponding MLME SAP is identified by a dedicated MAC address. This means that the H-MLD is provided with a dedicated MAC address for the P2P virtual station different from the MAC address used in the WLAN.

In a non-illustrated variant, a same SME SAP is used for controlling the whole MAC device, but an independent MLME is connected to the new virtual MAC. In this case, the SME SAP is able to handle several MAC addresses.

In another non-illustrated variant, the virtual MAC-SAP and SME-SAP may be implemented through a common MAC-SAP and SME-SAP but with a local index identifying the respective P2P SAPs.

Optionally, the architecture of FIG. 10 may provide the advantage of providing concurrent operation to the WLAN BSS on the same link. In this case, the connection 1050 may be dynamically maintained or not on the “P2P” link for legacy affiliated STA(s). This way of operating allows using a same primary channel for the co-located stations of the H-MLD, that is to say the same low-MAC and PHY couple is shared by P2P group and WLAN,

Nevertheless, the present approach using a virtual station requires directly routing the MSDU for the peer STA to the appropriate MAC SAP. This has to be performed by a layer-2 bridging, outside the H-MAC, thanks to the different MAC addresses attributed by the P2P virtual station and the BSS station.

In more details regarding the addressing, the V-MAC SAP exports the MAC address of low layer PHY 1040 as P2P Interface Address. If concurrent operation is performed over 1040, then the P2P affiliated STA determines a new MAC address applied for P2P operation on 1040, distinct from the one used for infrastructure operation, and this address with be used also by V-MAC SAP for interfacing within P2P group.

The P2P SAP Interfaces expire at the end of a P2P Group session when the virtual affiliated P2P station 1030 is de-activated.

According to a second aspect, the present invention intends to provide new mechanisms that improve discovery of such “P2P communication groups” formed by an affiliated station configured as P2P Group Owner.

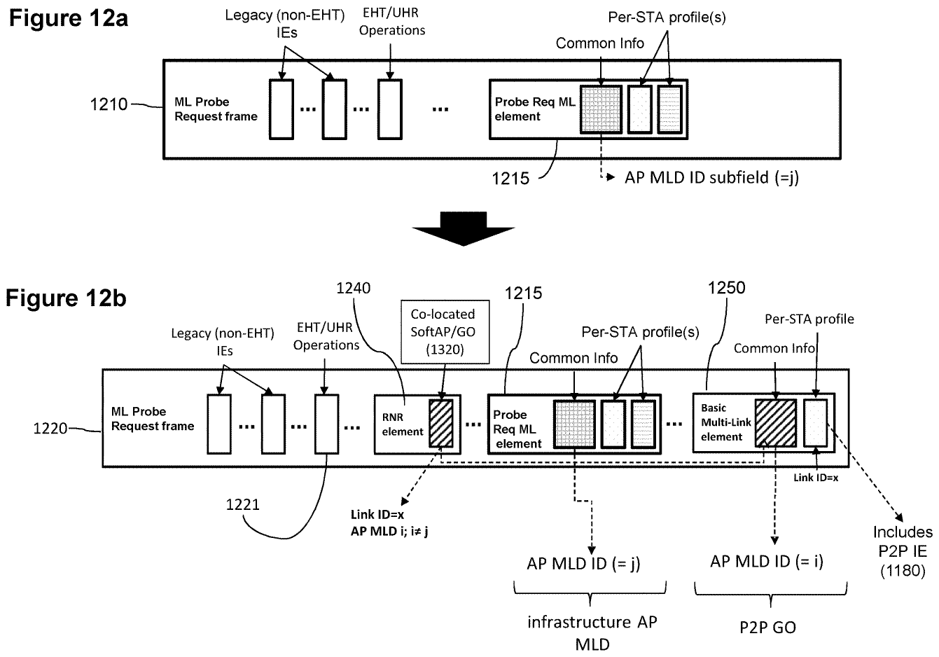

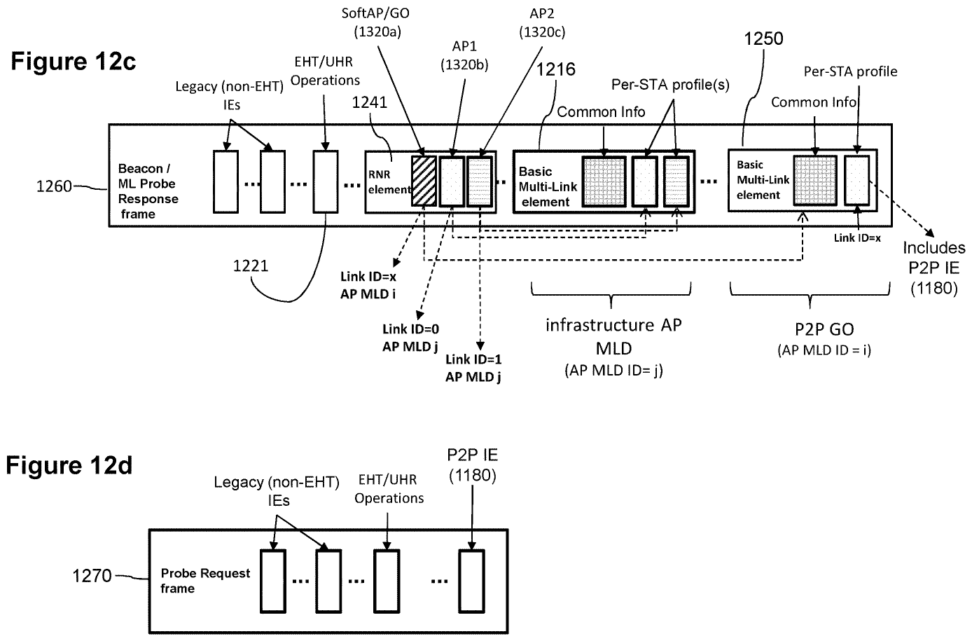

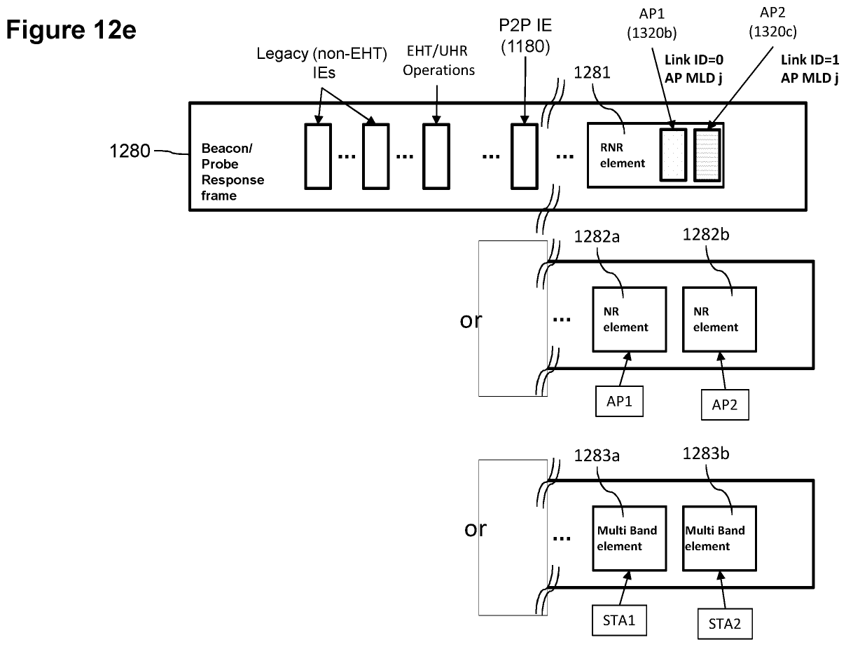

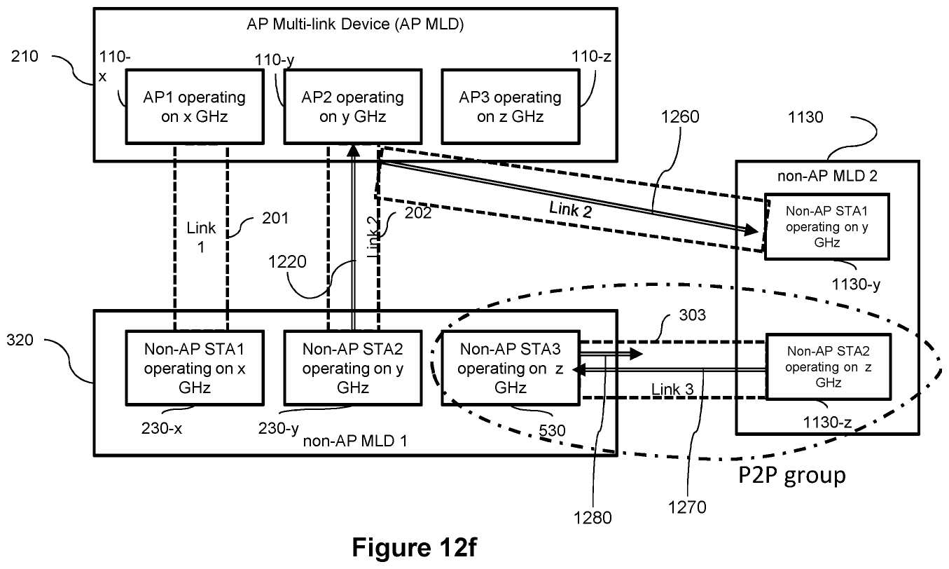

According to embodiments a second affiliated station (230), operating in the WLAN, sends P2P discovery frames indicating the first affiliated station (530) is a P2P Group Owner as illustrated by FIG. 11. In some embodiments, second affiliated station, operating in the WLAN, can report to the AP of an infrastructure BSS, about the P2P group, in order to allow the existing AP to advertise about the communication group over its operating channel, as illustrated by FIG. 12a-12f.

The stations operating on the same channel(s) or link(s) as the existing AP MLD then become aware of the P2P group without having to scan multiple channels. They may then decide to join the P2P group by switching to the corresponding operating channel and establish a new (P2P) link on that channel.

The operating link of the P2P GO of the Hybrid MLD may be or may not be operated by the infrastructure AP, therefore the Link ID value used for identifying the P2P link can be independent of Link ID advertised by infrastructure AP. This means that embodiments provide support of different channels or links for P2P and infrastructure operations, which is more efficient for the data communications

Thanks to this assistance for advertising the P2P communication group, the average time needed by stations to discover the group is made shorter. Hence, the initial link setup time to establish a communication link between e.g. P2P device and soft AP (P2P GO) is substantially decreased.

FIGS. 11a-11c illustrate the process of P2P Invitation procedure for an Hybrid MLD according to embodiments. This embodiment is advantageous when the hybrid MLD wants to invite a known remote device to join a P2P it hosted in one of its affiliated stations. By known device we intend here a station of the infrastructure BSS, which has provided capability information 703 to join the P2P group as described above in relation with FIG. 7a.

P2P Invitation procedure is an optional procedure that is generally used by a P2P Group Owner for inviting a P2P Device to become a P2P Client in its P2P Group.

To signal P2P attributes in the Management frames exchanged, P2P protocol communication is based on the use of a so-called P2P Information Element (P2P IE, 1180) as depicted in FIG. 11a. It is based on the Vendor Specific Information Element as defined in IEEE Std 802.11-2012, wherein Element ID 1181 is set to 0xDD to signal a P2P IE, Length field 1182 indicates the length in bytes of the IE, WFA OUI field 1183 indicates WFA specific organization identifier and OUI Type field 1184 indicates P2P version. WFA refers to Wi-Fi Alliance and OUI to Organization Unique Identifier.

A number of P2P attributes 1190 is defined. A single P2P IE may carry one or more P2P attributes 1190. The P2P attributes 1190 are defined to have a common general format consisting of a 1-octet P2P Attribute ID field, a 2-octet Length field and variable-length attribute-specific information fields.

The P2P Invitation Request/Response frames are Public Action frames (1100), as depicted by FIG. 11b.

The Category field 1101 takes value 4 to identify an IEEE 802.11 public action usage.

A Public Action field 1102, in the octet immediately after the Category field, differentiates the different Public Action frame formats: value 9 stands for Vendor Specific usage.

The Organization Identifier (OUI) field 1103 is 3 octets in length, and takes hexadecimal value ‘50 6F 9A’ for Wi-Fi Alliance specific OUI.

OUI Subtype identifies the type of P2P public action frame (for the previously specified OUI): Value 3 for P2P Invitation Request, value 4 for P2P Invitation Response.

The Dialog Token 1106 is set to a nonzero value to identify the request/response transaction.

The Elements field 1107 is length variable and includes P2P IE (1180) or any information elements defined in IEEE802.11-2020.

A P2P Invitation Request frame transmitted to the AP MLD by an affiliated station 230 co-located to the P2P Group Owner in an hybrid MLD shall include the P2P Group ID, P2P Group BSSID, Channel List, Operating Channel, and Configuration Timeout attributes in the P2P IE (in Elements 1107) corresponding to the P2P group.

The Operating Channel attribute indicates the Operating Channel of the P2P Group operated by GO, which corresponds to the channel of the link where is located the GO. The Channel List attribute usually indicates the channels and Operating Class that a P2P Device can support. Therefore it is limited to the value taken by Operating Channel attribute of the P2P Group as no negotiation of channel is intended.

The P2P Group ID attribute (Attribute ID=15) contains a unique P2P Group identifier of the P2P Group, for example formed by the pair {P2P Device address of the P2P Group Owner, and SSID}. As already disclosed, the P2P Group Identifier takes the station association identifier (STA AID) value of the first affiliated non-AP station acting as Group Owner.

The P2P Device Info attribute (Attribute ID=13) contains information on a P2P Device (Device Address, configuration method, device Name etc.).

The Client Configuration Timeout field in the Configuration Timeout attribute shall be set to 0.

The Invitation Flags attribute contains flags used in the P2P Invitation procedure and aiming at differentiating between uses of P2P Invitation Request. Currently only Bit 0 is used: it is set to 1 to indicate a P2P Invitation Request to re-invoke a Persistent Group, or set to 0 to indicate a P2P Invitation Request to join an active P2P Group. Value 0 is to be used.

In addition, one may consider using bit 1 (currently Reserved, meaning not used) to indicate the Invitation is provided by a device non-member of the P2P group (as 230 in the context of Hybrid MLD).

FIG. 11c illustrates a P2P Invitation Request/Response frames conveying according to embodiments. The P2P Invitation Request frame 1110 is emitted by Non-AP STA2 230-y of device 320 towards a device 1130. This device can be a legacy device, like device 330 of FIG. 5, or a Hybrid MLD 1130 as illustrated in FIG. 11c. In the latter case, the device 1130 may use the information, namely the P2P attributes, in the received P2P element of the P2P Invitation frame to setup an affiliated station 1130-z on link 3 where channel ‘z’ corresponds to the operating channel of the P2P group.

In details, as two non-AP MLDs 320/1130 have performed multi-link setup with the same AP MLD 210, the pathway for P2P Invitation Request frame 1110 goes by the AP MLD to further reach the device 1130.

Frames that traverse the intermediate AP MLD are sent or received by a non-AP STA affiliated with a non-AP MLD 1130. As shown in the figure, the P2P Invitation Request frame is transmitted by the non-AP MLD 320 through affiliated station 230-y to MLD 1130 through affiliated station 1130-y on link 2.

The addressing of P2P Invitation Request frame (1110) is as follow:

The value of the Address 1 (DA/RA) field in the MAC header of the frame is the MAC address of the receiving STA affiliated with the MLD corresponding to that link, in the example, MAC address of station 1130-y.

The value of the Address 2 (TA/SA) field in the MAC header of the frame is the MAC address of the transmitting STA affiliated with the MLD corresponding to that link, in the example, MAC address of station 230-y.

The value of the Address 3 field (BSSID) in the MAC header of the frame is set to the BSSID of the AP affiliated with the AP MLD corresponding to that link, in the example, BSSID of AP2 110-y.

Then, the P2P Invitation Response frame is preferably emitted over the direct link 303. The initiating non-AP MLD 1130 is able to determine the link on which the peer STA or non-AP MLD is operating on: all information inside the P2P element in the request are useful for that determination.

The P2P Invitation Response frame 1120 uses the P2P public action frame format.

As a result, the Dialog Token field 1106 is set to a nonzero value received in the P2P Invitation Request frame to identify the request/response transaction. Note that this token was set by second affiliated station 230 in the P2P Invitation Request frame and received by the P2P GO 530 in the P2P Invitation Response frame, therefore this value has to be exchanged internally between the two affiliated stations of the non-AP MLD 320.

The Elements field in the P2P Invitation Response frame contains a P2P IE which includes: the Status attribute used to signal status information in the response frame of the invitation request-response transaction. The value may be 0 (Success) if the invitation is accepted, otherwise the Status attribute is set to the appropriate failure code such as: 2 (Fail; incompatible parameters), 7 (Fail; no common channels) when no link is common in between two peers; the Configuration Timeout attribute keeps value 0; the Operating Channel attribute keeps same value as equivalent attribute in the request; the P2P Group BSSID attribute keeps same value as equivalent attribute in the request; and the Channel List attribute keeps same value as equivalent attribute in the request.

The addressing of P2P Invitation Request frame (1110) is as follow: the value of the Address 1 (DA/RA) field and Address 3 field (BSSID) in the MAC header of the frame takes the BSSID of intended P2P GO; the value of the Address 2 (TA/SA) field in the MAC header of the frame is the MAC address of the transmitting STA affiliated with the MLD corresponding to that link, in the example, MAC address of station 230-y.

This addressing may be indicative per bit 1 of The Invitation Flags attribute that the recipient of the invitation response is not a P2P device of the intended P2P group, then response has to be addressed to P2P GO.

As a result, the exchange of P2P Invitation frame can be seen as a new Out-of-Band Device Discovery using affiliated stations of the Hybrid MLD.

Then, the invited device can listen to management frames from the P2P GO on the link to associate with it.

FIGS. 12a-12f illustrate the process of advertisement of a P2P group via the infrastructure BSS according to embodiments of the invention.

The following description is referring to Multi-Link procedures, in a way that Beacon and Probing frames contain Multi-Link Information elements introduced by 802.11be. Legacy devices, namely devices using the standard prior to 802.11be, are still able to understand those frames, but will ignore the ML Information Elements.

Management frames exchanged during the ML discovery and ML setup procedures contains a new Information Element specific to the Multi-Link Operation (MLO), referred to as Basic Multi-Link element, which conveys a description of the affiliated STA entities of the MLD sending the frame other than the sending affiliated STA entity known as “reporting STA”. More precisely, the profile of the reporting STA is provided in Information Elements, IEs, of the frame outside the Basic Multi-Link element. The Basic Multi-Link element carries one or more Per-STA Profile subelements corresponding to each additional affiliated STA, known as “reported STA”, within the same MLD. The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters.

In an active scanning, a non-AP STA transmits a Probe Request frame (with a wildcard SSID) and waits for a Probe Response frame from an AP. The active discovery process thus mainly relies on the exchange of Probe Request and Probe Response frames between an AP and a non-AP. For ML discovery, the discovery procedure may be performed either by using a Probe Request/Response frame exchange per link or one ML Probe Request/Response frame exchange carrying all the information of the various APs affiliated to the AP MLD on one of the available links.

Current 802.11be revision also defines a specific Multi-Link element, so-called Probe Request Multi-Link element, regarding the Probe Request frames to which Probe Response frames can be sent by the AP MLD. The Probe Request Multi-Link element is used to request a reporting AP to provide information (complete or partial profile) of other (reported) APs affiliated with the same AP MLD as the reporting AP. The Probe Request Multi-Link element includes Per-STA Profile fields for each requested reported AP.

FIG. 12a schematically illustrates a Probe Request frame 1210 according to IEEE802.11be, in which the Probe Request Multi-Link element 1215 includes common information and one Per-STA profile per each requested reported AP.

As either the Address 1 field or the Address 3 field of the multi-link probe request is set to the MAC address of the responding AP that operates on the same link where the multi-link probe request is sent, then the AP MLD ID subfield shall be present in the Probe Request Multi-Link element of the multi-link probe request so that the targeted AP MLD is identified by the AP MLD ID subfield, which is set to the same AP MLD ID value as the one used by the AP in beacon frames.

If the Probe Request Multi-Link element in the multi-link probe request does not include any per-STA profile, then all APs affiliated with the same AP MLD as the AP identified in the Address 1 or Address 3 field or AP MLD ID of the multi-link probe request are requested APs.

In shown the figure, the AP MLD ID is set to exemplary value ‘j’, as advertised by AP MLD in beacon frames emitted on the various setup links.

FIG. 12b schematically illustrates the content of a Multi-Link Probe Request frame 1220 according to embodiments of the invention.

The ML Probe Request frame 1220 adds new elements 1240 and 1250 to the original frame 1210.

Element 1240 is a conventional reduced Neighbor Report (RNR) information element, even if such element is not envisaged to be inserted in a ML Probe Request frame per IEEE802.11 standard. Element 1250 is a new Multi-Link element that carries only information about the AP as indicated in the RNR 1240 of the ML Probe Request 1220. In embodiments, the Multi-Link element 1250 is based on the format of Basic ML Element.

As already discussed, a multi-link probe request allows a non-AP STA affiliated with a non-AP MLD to request an AP affiliated with an AP MLD to include the complete or partial set of capabilities, parameters and operation elements of the AP(s) affiliated with the targeted AP MLD (identified by 1215). This new format of multi-link probe request 1220 allows the second non-AP STA affiliated with a non-AP MLD to inform an AP MLD, via an AP affiliated on the link, of the presence of a complete or partial set of capabilities, parameters and operation elements of the P2P Go/softAP operated by a first affiliated Station of an Hybrid MLD.

Traditionally, a multi-link probe response is a Probe Response frame that is transmitted in response to a received multi-link probe request and that includes Basic Multi-Link element which can carry complete or partial profile(s), based on the soliciting request, for each of the requested AP(s) affiliated with the targeted AP MLD. Therefore, only APs related to Probe Request ML element 1215 will be carried in the ML Probe Response (that is to say the ML Probe Response will not carry any information related to 1250).

The AP MLD ID for infrastructure AP MLD operations takes value advertised by the AP MLD, e.g. value ‘j’.

As a result, the AP MLD ID in RNR 1240 and ML Element 1250 shall be set to a different value; e.g. value ‘i’ to indicate that these elements are not related to the infrastructure BSS.

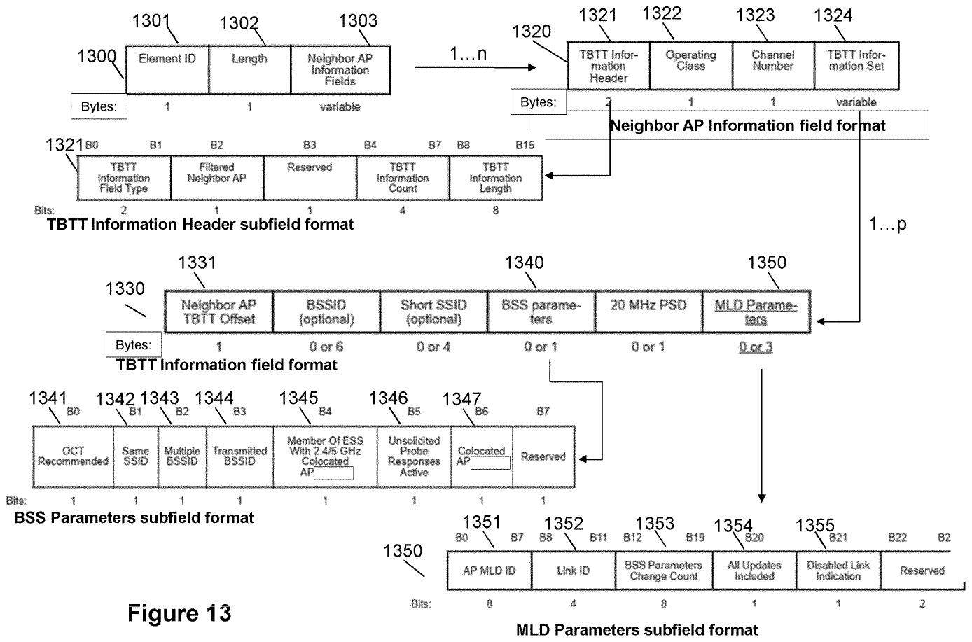

FIG. 13 illustrates the format of the Reduced Neighbor Report (RNR) information element 1300.

Specific values will be provided when RNR 1300 is an RNR 1240 included in ML Probe Request frame 1220.

The RNR element 1300 contains channel and other information related to neighbor APs, which include “reported APs” in the context of Multi-link environment.

Element ID field 1301 is equal to value 101 to indicate the information element is a RNR element. Length field 1302 specifies the length, in octets, of the information element including the Neighbor AP information Fields field 1303.

Neighbor AP information Fields field 1303 contains a set of one or more (“n” in the illustrated example) Neighbor AP Information fields 1320, each providing elements or network information about a neighbour or “reported” AP different from the reporting AP (AP sending the information element). Specific to RNR 1240, n equals 1 as there is only one P2P GO in the hybrid MLD that is simple link. Of course, more than one P2P GO may be envisaged in the hybrid MLD, each on a given link (therefore a distinct operating class and channel): individual elements 1321 have to be considered).

Each Neighbor AP Information field 1320 comprises a Target Beacon Transmission Time, TBTT, expressed in Time Units, TUs, information header subfield 1321, an Operating Class subfield 1322, a Channel Number subfield 1323 and a TBTT information Set subfield 1324, all related to a given reported AP.

TBTT Information Header subfield 1321 contains several fields that indicate how many TBTT Information fields 1330 are present in the TBTT Information Set subfield 1324 (e.g. TBTT Information count, indicating of the number of TBTT Information fields included in 1324), and their length type (TBTT Information Field Type has value 0 or 1 for 802.11 devices operating in bands greater than 1 Mhz). Multiple reported APs that have the same operating channel are reported in the same TBTT Information Set subfield 1324 (“p” in the illustrated example). Specific to RNR 1240, p equals 1 as there is only the P2P GO to be reported.

Operating Class field 1322 indicates a channel starting frequency that, together with the Channel Number field 1323, defines the primary (hence operating) channel of the BSS of the reported AP(s) corresponding to that Neighbor AP Information field 1320. Specific to RNR 1240, those fields correspond to the operating link of the P2P GO of the Hybrid MLD.

Each TBTT Information field 1330 comprises various fields, including a Neighbor AP TBTT Offset subfield 1331, a BSS Parameters subfield 1340 and possibly an MLD Parameters subfield 1350.

Neighbor AP TBTT Offset subfield 1331 indicates the offset in TUs, rounded down to nearest TU, to the next TBTT of the reported AP's BSS from the immediately prior TBTT of the reporting AP that transmits this element. Value 254 indicates an offset of 254 TUs or higher. Value 255 indicates an unknown offset value. The RNR 1240 may consider using 255, in fact, the TBTT is the same as the TBTT of infrastructure BSS.

BSS Parameters subfield 1340 comprises various fields, including:
OCT Recommended subfield 1341 set to 1 to indicate that On-channel Tunneling (OCT) is recommended to exchange MMPDUs with the reported AP identified in the TBTT Information field (otherwise set to 0). The RNR 1240 may consider using value 0.
Same SSID subfield 1342 set to 1 to indicate that the reported AP has the same SSID as the reporting AP (otherwise set to 0). The RNR 1240 may consider using value 0.
Multiple BSSID subfield 1343 set to 1 to indicate that the reported AP is part of a multiple BSSID set (otherwise set to 0). The RNR 1240 may consider using value 0.
Transmitted BSSID subfield 1344 set to 1 to indicate that the reported AP is a transmitted BSSID (otherwise set to 0). The RNR 1240 may consider using value 0.
Member Of ESS With 2.4/5 GHz Colocated AP subfield 1345 indicating whether the reported AP is part of an ESS that has no 6 GHz-only APs that might be detected by a STA receiving this frame. This means that all APs operating in the 6 GHz band that are part of that ESS that might be detected by a STA receiving this frame can be discovered in the 2.4 GHz and/or 5 GHz bands. The RNR 1240 may consider using value 0.
Unsolicited Probe Responses Active subfield 1346 set to 1 to indicate the reported AP is part of an ESS where all the APs are transmitting unsolicited Probe Response frames every 20 TUs or less (this is for scanning operations in 6 GHz) (otherwise set to 0). The RNR 1240 may consider using value 0.
Colocated AP subfield 1347 set to 1 to indicate when the reported AP is in the same colocated AP set as the transmitting/reporting AP (otherwise set to 0). The RNR 1240 may consider using value 1 as the P2P GO is colocated with affiliated stations that are associated with the AP MLD. This bit easily helps a recipient device to determine that the reported neighboor AP is located in an Hybrid MLD.

MLD Parameters field 1350 contains information about the link associated with the reported AP, in particular includes AP MLD ID subfield 1351, Link ID subfield 1352, BSS Parameters Change Count subfield 1353, All Updates Included subfield 1354 and Disabled Link Indication subfield 1355.

AP MLD ID subfield 1351 specifies the identifier of the AP MLD to which the reported AP is affiliated. It is to be noted that an RNR is classically sent by an AP, not by a non-AP station as it is the case in present embodiments of the invention. If the reported AP is affiliated to the same MLD as the reporting AP, MLD ID subfield 1351 is set to 0. Otherwise, if the reported AP is part of another AP MLD, AP MLD ID subfield 351 is set to a value higher than 0. According to embodiments, the AP MLD ID subfield is set to a value chosen by the reporting non-AP station (e.g. 230-y) to uniquely identify the MLD of the reported P2P GO (with regards to FIG. 12b, the AP MLD ID in RNR 1240 and ML Element 1250 are set to a value ‘i’). Preferably, the MLD ID value is selected in consideration of existing values used in the infrastructure BSS: when multiple BSSIDs are setup by infrastructure AP, the value to be used is then higher than 2ⁿ−1 and lower than 255 (n corresponding to the value of the MaxBSSID Indicator of the infrastructure AP).

Link ID subfield 1352 is the unique identifier (within an MLD) of the link corresponding to the reported AP. Link ID subfield 1352 is set to 15 if the reported AP is not part of an AP MLD, or if the reporting AP does not have that information. The RNR 1240 may consider using any value as it is unique in the context of the new MLD ID. As alternative, the Link ID value for the P2P GO's link is set to a same value (if any) as the one identifying same link by the infrastructure AP MLD, e.g. corresponding to link 2 as illustrated by FIG. 12f.

BSS Parameters Change Count subfield 1353 contains a counter that is incremented, modulo 255, each time a critical parameter of the BSS managed by the reported AP is updated in the Beacon frame. All Updates Included subfield 1354 indicates, in case of update, if all updated elements are present in the current RNR report. It is therefore set to 0 in the RNR 1240.

Disabled Link Indication subfield 1355 is set to 1 if the reported AP is operating on a link that is advertised as disabled and the reported AP is affiliated with the same AP MLD as the reporting AP. It is therefore set to 0 in the RNR 1240.

As thus defined, MLD Parameters field 1350 allows a link (through the Link ID subfield 1352 and MLD ID 1351) to be made between a Neighbor AP Information field 1320 defining a reported AP in the RNR element 1240 (format 1300) and the corresponding Per-STA Profile subelement for the same reported AP in the Multi-Link element 1250. This is for instance illustrated in FIG. 12b, through the arrow.

Back to FIG. 12b, the ML Element 1250 is composed of a Common Info field and a Per-STA Profile. Either one can convey a P2P IE 1180.

Preferably, P2P IE 1180 includes the P2P Group ID, P2P Group BSSID, Channel List, Operating Channel, and Configuration Timeout attributes in the P2P IE corresponding to the P2P group. Those are subset of P2P elements that are required to locate and identify the P2P Group. Of course, this subset can be even more reduced by omitting Channel List, Operating Channel elements as already disclosed in Operating Class 1322 and Channel Number 1323 of RNR.

FIG. 12c illustrates the format of beacon or ML Probe Response frames 1260 as sent by infrastructure AP MLD 210 once one of its affiliated AP (e.g. 110-y) has received the ML Probe Request frame 1220.

As AP MLD 210 is multi-link, an RNR can be used to provide information (complete or partial profile) of other reported APs affiliated with the same AP MLD: The elements 1320b and 1320c refers to Per-STA profile per each reported AP in the Basic Multi-Link element 1216.

The illustrated RNR 1241 embeds those information (1320b, 1320c), and adds a new reported AP outside the AP MLD 210. A new Neighbor AP Information field 1320a is inserted based on the received RNR 1240 in ML Probe Request frame 1220 in FIG. 12b, and forwards detailed information present in Multi-Link Element 1250. Thanks to a dedicated MLD ID, RNR 1320a identifies ML element 1250 and the Per-STA profile that includes P2P IE 1180.

As those elements would be re-posted by the AP MLD in beacon or ML Probe Response frames 1260, having a reduced set of P2P attributes in frame 1220 aims to avoid management frame bloating regarding ML probe response 1260.

As an alternative, P2P IE 1180 may include all P2P elements that may be obtained via beacon frames on the targeted link (P2P Capability, P2P Device ID, Listen Channel, Extended Listen Timing, P2P Device Info, Operating Channel, Service Hash). This helps the recipient non-AP station that intends to join the P2P group to directly issue a Probe Request Frame illustrated by the example frame 1270 in FIG. 12d.

FIG. 12e illustrates alternative embodiments of the ML probe response. These embodiments may also be used in the beacons emitted by the softAP/GO.

These embodiments provide that the soft AP (P2P GO) can notify in its beacon/Probe Response frames 1280, in addition to information on the P2P group provided in the P2P IE 1180, that at least one of its co-located affiliated stations are operating with the AP of an infrastructure BSS. Therefore, a device willing to operate as a P2P device of the P2P link can more easily select a P2P Group for which the GO is embedded in an hybrid MLD in relation to the intended infrastructure BSS.

This can be supported by the insertion of at least one Neighbor Report, NR, Element:

Neighbor Element can be an RNR 1281 as illustrated in FIG. 12d, which contains several Neighbor AP Information fields 1320a and 1320b, each indicating a reported AP of the infrastructure AP MLD. In addition, it is envisaged that MLD Parameters subfield format 1350 provides one of its reserved bits (B22-B23) to indicate “P2P Concurrent Device” capability. This bit informs the recipient peer that an affiliated non-AP STA of the hybrid MLD operates with that link as P2P Concurrent Device operation (in other words, the GO can operate on a first link concurrently to a WLAN STA in second link for the infrastructure WLAN as specified by RNR element).

Neighbor Element can be formed of several Neighbor Report elements 1282a and 1282b according to IEEE802.11 format, each corresponding to a reported AP of the infrastructure AP MLD. Similarly to modified RNR, it is envisaged that the Capabilities subfield provides one of its reserved bits (B4-B5) as a capability of a non-AP affiliated STA of the Hybrid MLD to indicate “P2P Concurrent Device” mode.

Neighbor Element can be formed of several Multi Band elements 1283a and 1283b according to IEEE802.11-2020 format, each corresponding to a reported non-AP STA of the hybrid MLD. The Band ID field provides the identification of the frequency band related to the provided Operating Class and Channel Number fields, therefore the affiliated STA is clearly identified. The STA Role subfield (in the Multi-Band Control field) specifies the role the transmitting STA plays on the channel of the operating class indicated in this Multi-Band element. Possibly, a new value for STA Role is envisaged in Table 9-265 of IEEE802.11-2020, to indicate the “Hybrid MLD” Role (in other words, a P2P Concurrent Device operation by this affiliated STA within the Hybrid MLD). It is to be noted that this Multi-band information is not intended for Fast BSS switching as legacy Multi-Band elements. In present embodiment, this allows the multi-band capable P2P Device to signal support to more than one frequency band for WLAN concurrent operation (The BSSID field specifies the BSSID of the infrastructure BSS operating on the channel and frequency band indicated by the Channel Number and Band ID fields).

FIG. 12f illustrates the link location of various management frames 1220, 1260, 1270 and 1280 described in relation to previous figures according to embodiments.

Management frame 1220 is a Probe Request frame sent by an affiliated non-AP STA according to embodiments of the invention in order to report the P2P group to the AP MLD.

Management frame 1260 is a Beacon frame or Probe Response frame sent by the AP MLD to stations and reporting, according to embodiments of the invention, the P2P group to stations of the infrastructure BSS. The reported information corresponds to information received in a Probe request 1220.

Management frame 1270 is a classical Probe Request frame containing P2P attributes (1180) and emitted towards the P2P GO on its operating link 3.

Management frame 1280 is a Probe response sent by the softAP/GO on link 3 in response to the Probe request 1270 according to embodiments of the invention and reporting AP affiliated stations of the AP MLD and/or the non-AP affiliated stations of the hybrid MLD according to embodiments of FIG. 12e.

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of transmission in a wireless network, the method comprising:
configuring a first affiliated non-Access Point, non-AP, station of a non-AP Multi Link Device, MLD, as a Peer to Peer, P2P, station for communicating with a peer station in a first Basic Service Set, BSS, forming a P2P group; and
configuring at least one second affiliated non-AP station of the non-AP MLD as station for communicating with an AP in a second BSS.

2. The method of claim 1, wherein the second affiliated non-AP stations of the non-AP MLD are configured for communicating with respective affiliated AP stations of an AP MLD.

3. The method of claim 2, wherein the first affiliated non-AP station ceases transmission to the AP MLD once configured for communicating in the P2P group.

4. The method of claim 1, wherein the method further comprises:
disassociating the first affiliated non-AP station from an affiliated AP station of the AP MLD prior configuring the first affiliated non-AP station as a P2P station.

5. The method of claim 1, wherein the first affiliated non-AP station being configured to communicate with the peer station on a first channel of the first BSS and the at least one second affiliated non-AP station being configured to communicate with the AP on at least one second channel of the second BSS, the method comprises:
reporting the P2P group and the first channel, by the at least one second affiliated non-AP station of the non-AP MLD, to the AP MLD.

6. The method of claim 5, wherein reporting the P2P group comprises transmitting a P2P Information Element, IE.

7. The method of claim 6, wherein the P2P IE is transmitted in a P2P Invitation Request frame transmitted on the second channel by the at least one second affiliated non-AP station to the AP MLD to be transmitted to another station connected to the AP MLD.

8. The method of claim 6, wherein the P2P IE is transmitted in a Multi-Link IE of a Probe Request frame.

9. The method of claim 8, wherein the Probe Request frame further comprises a Reduced Neighbour Report, RNR, IE identifying the first non-AP affiliated station operating as a Group Owner, GO, of the P2P group, in addition to the Multi-Link IE including information of the GO, and wherein the RNR IE and ML IE include an MLD ID subfield and a link ID subfield, respectively set to same value but distinct from respective subfield values used for the second BSS.

10. The method of claim 8, further comprising:
transmitting the P2P IE, by the AP MLD, in a Probe Response frame or in a beacon frame on the second channel, wherein the P2P IE is included in a per-STA profile in a first Basic Multi-Link IE.

11. (canceled)

12. The method of claim 10, wherein the beacon frame or Probe Response frame further comprise, in addition to the first Basic Multi-Link IE:
a RNR IE identifying the AP affiliated station of the AP MLD and the non-AP affiliated station operating as a Group Owner, GO, of the P2P group;
a second Basic Multi-Link IE including information of the AP affiliated station of the AP MLD, and wherein
an MLD ID subfield in RNR IE and Basic Multi-Link IEs is used to indicate whether a reported AP belongs to the first or second BSS.

13. (canceled)

14. A computer-readable storage medium storing instructions of a computer program for implementing a method according to claim 1.

15. (canceled)

16. A non-access point, AP, multi-link device, MLD, comprising a first affiliated non-AP station and at least one second affiliated non-AP station, wherein the non-AP MLD is capable of configuring simultaneously the first affiliated non-AP station as a peer-to-peer, P2P, station for communicating with a peer station in a first basic service set, BSS, forming a P2P group and the second affiliated non-AP stations as stations for communicating with an access point in a second BSS.

17. The non-AP MLD of claim 16, wherein the first BSS and the second BSS are not part of a same extended service set, ESS.

18. The non-AP MLD of claim 16, wherein the second affiliated non-AP stations are configured as stations for communicating each with an affiliated AP station of an AP MLD.

19. The non-AP MLD of claim 16, wherein the second affiliated non-AP stations are configured as stations for communicating with a non-MLD AP station.

20-26. (canceled)

27. The non-AP MLD of claim 16, wherein the first BSS operates a Wi-Fi Direct specification, and wherein the P2P Group Identifier of said first BSS takes the station association identifier (STA AID) value of the first affiliated non-AP station acting as Group Owner.

28. The non-AP MLD of claim 16, wherein the non-AP MLD is configured to provide a multi-link information element to the AP, the multi-link information element providing capacity information for a station to join the P2P group.

29. The non-AP MLD of claim 16, wherein the first affiliated non-AP station being configured to communicate with the peer station on a first channel of the first BSS and the at least one second affiliated non-AP station being configured to communicate with the AP on at least one second channel of the second BSS, the non-AP MLD is configured for:
reporting the P2P group and the first channel, by the at least one second affiliated non-AP station of the non-AP MLD, to the AP MLD.

30. The non-AP MLD of claim 29, wherein reporting the P2P group comprises transmitting a P2P Information Element, IE, wherein the P2P IE is transmitted in a P2P Invitation Request frame transmitted on the second channel by the at least one second affiliated non-AP station to the AP MLD to be transmitted to another station connected to the AP MLD.

31. (canceled)

32. The non-AP MLD of claim 30, wherein reporting the P2P group comprises transmitting a P2P Information Element, IE, wherein the P2P IE is transmitted in a Multi-Link IE of a Probe Request frame.

33. The non-AP MLD of claim 32, wherein the Probe Request frame further comprises a Reduced Neighbour Report, RNR, IE identifying the first non-AP affiliated station operating as a Group Owner, GO, of the P2P group, in addition to the Multi-Link IE including information of the GO, and wherein the RNR IE and ML IE include an MLD ID subfield and a link ID subfield, respectively set to same value but distinct from respective subfield values used for the second BSS.

34. The non-AP MLD of claim 32, further configured for:
receiving the P2P IE, from the AP MLD, in a Probe Response frame or in a beacon frame on the second channel, wherein the P2P IE is included in a per-STA profile in a first Basic Multi-Link IE.

35. (canceled)

36. The non-AP MLD of claim 34, wherein the beacon frame or Probe Response frame further comprise, in addition to the first Basic Multi-Link IE:
a RNR IE identifying the AP affiliated station of the AP MLD and the non-AP affiliated station operating as a Group Owner, GO, of the P2P group;
a second Basic Multi-Link IE including information of the AP affiliated station of the AP MLD, and wherein
an MLD ID subfield in RNR IE and Basic Multi-Link IEs is used to indicate whether a reported AP belongs to the first or second BSS.

37. A non-access point, AP, multi-link device, MLD, comprising a first affiliated non-AP station and at least one second affiliated non-AP station,
wherein the non-AP MLD comprises an upper MAC sublayer common to the first affiliated non-AP station and to the second affiliated non-AP station;
wherein a single service access point, SAP, is provided to upper layers;
wherein the upper MAC sublayer is configured to receive from the SAP an entering data flow with an associated indication to isolate the entering data flow,
wherein the indication being a stream classification service identifier, SCSID, identifying an SCS stream.

38. A non-access point, AP, multi-link device, MLD, comprising a single service access point, SAP, to upper layers;
wherein the non-AP MLD comprising a tagging function at upper layers, configured to tag data flow prior to send the data flow to the SAP interface;
wherein the tagging comprising associating an SCSID to the data flow.

39. The non-AP MLD of claim 38, wherein the data flow is received via the SAP with the associated SCSID to isolate the data flow.
